(19) United States
(12) Patent Application Publication
(10) Pub. No.: US 2015/0156025 A1
(43) Pub. Date: Jun. 4, 2015

(54) MESSAGE SENDING AND RECEIVING METHOD, APPARATUS, AND SYSTEM

(71) Applicant: Huawei Technologies Co., Ltd., Shenzhen (CN)

(72) Inventors: Xian Zhu, Wuhan (CN); Guangying Li, Shenzhen (CN)

(21) Appl. No.: 14/577,907

(22) Filed: Dec. 19, 2014

Related U.S. Application Data
(63) Continuation of application No. PCT/CN2013/074409, filed on Apr. 19, 2013.

(30) Foreign Application Priority Data
Aug. 2, 2012 (CN) 201210273217.0

(51) Int. Cl. H04L 9/32; H04L 9/08

(52) U.S. Cl. CPC H04L 9/3263; H04L 9/0822

(57) ABSTRACT

A message sending method is disclosed. The message sending method includes: sending a client handshake message to a server, where the client handshake message carries identifiers of server certificates buffered by the client; receiving a server handshake message sent by the server, where when the server determines that the identifiers of the server certificates buffered by the client include an identifier of a certificate that the server is ready to use, the server handshake message carries the identifier of the certificate that the server is ready to use; searching for the server certificate corresponding to the identifier of the certificate that the server is ready to use, among the server certificates buffered by the client; and encrypting, by using a public key in a server certificate found by searching, a client key exchange message to be sent, and sending an encrypted client key exchange message to the server.

### CROSS-REFERENCE TO RELATED APPLICATIONS

This application is a continuation of International Application No. PCT/CN2013/074409, filed on Apr. 19, 2013, which claims priority to Chinese Patent Application No. 201210273217.0, filed on Aug. 2, 2012, both of which are hereby incorporated by reference in their entireties.

### TECHNICAL FIELD

The present invention relates to communications technologies, and in particular, to a message sending and receiving method, apparatus, and system.

### BACKGROUND

A Transport Layer Security (Transport Layer Security, TLS for short) protocol is a protocol widely used for identity authentication and secure transmission.

In TLS, security of authentication depends on security of a private key of a server and security of a certificate. It should be noted that the security of authentication is not based on confidentiality of the certificate. The certificate may be an open object, as long as integrity of the certificate is ensured. The integrity of the certificate may be ensured by a certificate authority (Certificate Authority, CA for short) center by affixing a digital signature to the certificate. When verifying integrity of a server certificate, any entity may use a CA certificate for verification.

However, integrity of the CA certificate is ensured by using another higher-level CA certificate affixed with a digital signature. In this way, a CA hierarchy is formed, where a CA certificate at a top layer is called a root certificate. If there is no higher-level CA certificate for a CA certificate, this CA certificate must be a root certificate. A client needs to load the root certificate with trust. A sequence of the server certificate, CA certificate, higher-level CA certificate, . . . , root certificate is called a certificate chain. One certificate chain generally includes 3 to 5 certificates.

In a TLS handshake process, a certificate chain is generally carried in a certificate (Certificate) message for transmission. Because a certificate is generally large, the transmission of the certificate message leads to a long time occupied by the TLS handshake process, and reduces a TLS connection speed.

In addition, generally a buffering technology is used for implementation of the TLS protocol. If messages in the TLS handshake process are buffered and then are sent at a time, waiting for an acknowledgement (Acknowledgement, ACK for short) from a peer before a next message can be sent may be avoided every time when a message is sent. However, due to uncertainty of a certificate message size, it is generally difficult to determine a size of a buffer. For example, if the size of the buffer is determined to be 1 KB, the certificate message is probably sent for multiple times. This also leads to a long time occupied by the TLS handshake process, and greatly reduces the TLS connection speed.

### SUMMARY

The present invention provides a message sending and receiving method, client, server, and system to shorten a time occupied by a TLS handshake process and improve a TLS connection speed.

According to a first aspect, an embodiment of the present invention provides a message sending method, including: sending, by a client, a client handshake message to a server, where the client handshake message carries identifiers of server certificates buffered by the client; receiving, by the client, a server handshake message sent by the server, where when the server determines that the identifiers of the server certificates buffered by the client include an identifier of a certificate that the server is ready to use, the server handshake message carries the identifier of the certificate that the server is ready to use; searching, by the client, for a server certificate corresponding to the identifier of the certificate that the server is ready to use, among the server certificates buffered by the client; and encrypting, by the client by using a public key in the server certificate found by searching, a client key exchange message to be sent, and sending an encrypted client key exchange message to the server.

According to a second aspect, an embodiment of the present invention provides a message sending method, including: sending, by a client, a first client handshake message to a server, where the first client handshake message carries an indication of not requiring the server to send a certificate; receiving, by the client, a server handshake message sent by the server, where the server handshake message carries an identifier of a certificate that the server is ready to use; and if the client finds, by searching, a server certificate corresponding to the identifier of the certificate that the server is ready to use, among server certificates buffered by the client, encrypting, by the client by using a public key in the server certificate found by searching, a client key exchange message to be sent, and sending an encrypted client key exchange message to the server.

According to a third aspect, an embodiment of the present invention provides a message receiving method, including: receiving, by a server, a client handshake message sent by a client, where the client handshake message carries identifiers of server certificates buffered by the client; sending, by the server, a server handshake message to the client, where when the server determines that the identifiers of the server certificates buffered by the client include an identifier of a certificate that the server is ready to use, the server handshake message carries the identifier of the certificate that the server is ready to use; and receiving, by the server, an encrypted client key exchange message sent by the client, where the encrypted client key exchange message is sent to the server after the client finds, by searching, the server certificate corresponding to the identifier of the certificate that the server is ready to use, among the server certificates buffered by the client, and encrypts, by using a public key in the server certificate found by searching, the client key exchange message to be sent.

According to a fourth aspect, an embodiment of the present invention provides a message receiving method, including: receiving, by a server, a first client handshake message sent by a client, where the first client handshake message carries an indication of not requiring the server to send a certificate; sending, by the server, a server handshake message to the client, where the server handshake message carries an identifier of a certificate that the server is ready to use; and receiving, by the server, an encrypted client key exchange message sent by the client after the client finds, by searching, the server certificate corresponding to the identifier of the certificate that the server is ready to use, among server certificates buffered by the client, where the encrypted client key exchange message is sent to the server after the client encrypts, by using a public key in the server certificate found by searching, the client key exchange message to be sent.

According to a fifth aspect, an embodiment of the present invention provides a client, including a first sending module, a first receiving module, a first searching module, and a first encrypting module. The first sending module is configured to send a client handshake message to a server, where the client handshake message carries identifiers of server certificates buffered by the client; and receive an encrypted client key exchange message from the first encrypting module, and send the encrypted client key exchange message to the server. The first receiving module is configured to receive a server handshake message sent by the server, where when the server determines that the identifiers of the server certificates buffered by the client include an identifier of a certificate that the server is ready to use, the server handshake message carries the identifier of the certificate that the server is ready to use; and transfer the identifier of the certificate that the server is ready to use to the first searching module. The first searching module is configured to receive, from the first receiving module, the identifier of the certificate that the server is ready to use, and search for a server certificate corresponding to the identifier of the certificate that the server is ready to use, among the server certificates buffered by the client; and transfer the server certificate found by searching to the first encrypting module. The first encrypting module is configured to receive, from the first searching module, the server certificate found by searching, encrypt, by using a public key in the server certificate found by searching, the client key exchange message to be sent, and transfer the encrypted client key exchange message to the first sending module.

According to a sixth aspect, an embodiment of the present invention provides a client, including a second sending module, a second receiving module, a second searching module, and a second encrypting module. The second sending module is configured to send a first client handshake message to a server, where the first client handshake message carries an indication of not requiring the server to send a certificate; and receive an encrypted client key exchange message from the second encrypting module, and send the encrypted client key exchange message to the server. The second receiving module is configured to receive a server handshake message sent by the server, where the server handshake message carries an identifier of a certificate that the server is ready to use; and transfer the identifier of the certificate that the server is ready to use to the second searching module. The second searching module is configured to receive, from the second receiving module, the identifier of the certificate that the server is ready to use, and search for a server certificate corresponding to the identifier of the certificate that the server is ready to use, among server certificates buffered by the client; and when finding, by searching, by searching, the server certificate corresponding to the identifier of the certificate that the server is ready to use, transfer a server certificate found by searching to the second encrypting module. The second encrypting module is configured to receive, from the second searching module, the server certificate found by searching, encrypt, by using a public key in the server certificate found by searching, the client key exchange message to be sent, and transfer the encrypted client key exchange message to the second sending module.

According to a seventh aspect, an embodiment of the present invention provides a server, including a third receiving module and a third sending module. The third receiving module is configured to receive a client handshake message sent by a client, where the client handshake message carries identifiers of server certificates buffered by the client; and transfer the identifiers of the server certificates buffered by the client to the third sending module. The third sending module is configured to receive, from the third receiving module, the identifiers of the server certificates buffered by the client, and send a server handshake message to the client, where when it is determined that the identifiers of the server certificates buffered by the client include an identifier of a certificate that the server is ready to use, the server handshake message sent by the third sending module carries the identifier of the certificate that the server is ready to use. The third receiving module is further configured to receive an encrypted client key exchange message sent by the client, where the encrypted client key exchange message is sent to the server after the client finds, by searching, the server certificate corresponding to the identifier of the certificate that the server is ready to use, among the server certificates buffered by the client, and encrypts, by using a public key in the server certificate found by searching, the client key exchange message to be sent.

According to an eighth aspect, an embodiment of the present invention provides a server, including a fourth receiving module and a fourth sending module. The fourth receiving module is configured to receive a first client handshake message sent by a client, where the first client handshake message carries an indication of not requiring the server to send a certificate; and send the indication of not requiring the server to send a certificate, to the fourth sending module. The fourth sending module is configured to receive, from the fourth receiving module, the indication of not requiring the server to send a certificate, and send a server handshake message to the client, where the server handshake message carries an identifier of a certificate that the server is ready to use. The fourth receiving module is further configured to receive an encrypted client key exchange message sent by the client after the client finds, by searching, the server certificate corresponding to the identifier of the certificate that the server is ready to use, among server certificates buffered by the client, where the encrypted client key exchange message is sent to the server after the client encrypts, by using a public key in the server certificate found by searching, the client key exchange message to be sent.

According to a ninth aspect, an embodiment of the present invention provides a message exchange system, where the system includes at least one client and at least one server. The client is configured to: send a client handshake message to the server, where the client handshake message carries identifiers of server certificates buffered by the client; receive a server handshake message sent by the server, where when the server determines that the identifiers of the server certificates buffered by the client include an identifier of a certificate that the server is ready to use, the server handshake message carries the identifier of the certificate that the server is ready to use; search for the server certificate corresponding to the identifier of the certificate that the server is ready to use, among the server certificates buffered by the client; and encrypt, by using a public key in a server certificate found by searching, a client key exchange message to be sent, and send an encrypted client key exchange message to the server. The server is configured to: receive the client handshake message sent by the client, where the client handshake message carries the identifiers of the server certificates buffered by the client; send the server handshake message to the client, where when the server determines that the identifiers of the server certificates buffered by the client include the identifier of the certificate that the server is ready to use, the server handshake message carries the identifier of the certificate that the server is ready to use; and receive the encrypted client key exchange message sent by the client, where the encrypted client key exchange message is sent to the server after the client finds, by searching, the server certificate corresponding to the identifier of the certificate that the server is ready to use, among the server certificates buffered by the client, and encrypts, by using the public key in the server certificate found by searching, the client key exchange message to be sent.

According to a tenth aspect, an embodiment of the present invention provides a message exchange system, where the system includes at least one client and at least one server. The client is configured to: send a first client handshake message to the server, where the first client handshake message carries an indication of not requiring the server to send a certificate; receive a server handshake message sent by the server, where the server handshake message carries an identifier of a certificate that the server is ready to use; and if the client finds, by searching, the server certificate corresponding to the identifier of the certificate that the server is ready to use, among server certificates buffered by the client, encrypt, by using a public key in the server certificate found by searching, a client key exchange message to be sent, and send an encrypted client key exchange message to the server. The server is configured to: receive the first client handshake message sent by the client, where the first client handshake message carries the indication of not requiring the server to send a certificate; send the server handshake message to the client, where the server handshake message carries the identifier of the certificate that the server is ready to use; and receive the encrypted client key exchange message sent by the client after the client finds, by searching, the server certificate corresponding to the identifier of the certificate that the server is ready to use, among the server certificates buffered by the client, where the encrypted client key exchange message is sent to the server after the client encrypts, by using the public key in the server certificate found by searching, the client key exchange message to be sent.

A technical effect of one aspect of the present invention is as follows: A client sends a client handshake message, which carries identifiers of server certificates buffered by the client, to a server; when the server determines that the identifiers of the server certificates buffered by the client include an identifier of a certificate that the server is ready to use, the server may not send a certificate message, but sends a server handshake message, which carries the identifier of the certificate that the server is ready to use, to the client; and then the client searches for the server certificate corresponding to the identifier of the certificate that the server is ready to use, among the server certificates buffered by the client, and encrypts, by using a public key in a server certificate found by searching, a client key exchange message to be sent, and sends an encrypted client key exchange message to the server. In the present invention, the server may not send a certificate message to the client, which may reduce an amount of data in a TLS handshake process and shorten a time occupied by the TLS handshake process, and may further improve a TLS connection speed, and may avoid a problem that a certificate message is sent for multiple times due to an excessively small buffer size, and thereby may further improve the TLS connection speed.

A technical effect of another aspect of the present invention is as follows: A client sends a first client handshake message, which carries an indication of not requiring a server to send a certificate, to the server; after receiving the first client handshake message, the server does not send a certificate message, but sends a server handshake message, which carries an identifier of a certificate that the server is ready to use, to the client; and if the client finds, by searching, the server certificate corresponding to the identifier of the certificate that the server is ready to use, among the server certificates buffered by the client, the client may encrypt, by using a public key in the server certificate found by searching, a client key exchange message to be sent, and send an encrypted client key exchange message to the server. In the present invention, the server may not send a certificate message to the client, which may reduce an amount of data in a TLS handshake process and shorten a time occupied by the TLS handshake process, and may further improve a TLS connection speed, and may avoid a problem that a certificate message is sent for multiple times due to an excessively small buffer size, and thereby may further improve the TLS connection speed.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show some embodiments of the present invention, and persons of ordinary skill in the art may still derive other drawings from these accompanying drawings without creative efforts.

FIG. 1 is a flowchart of an embodiment of a message sending method according to the present invention;

FIG. 2 is a flowchart of another embodiment of a message sending method according to the present invention;

FIG. 3 is a flowchart of an embodiment of a message receiving method according to the present invention;

FIG. 4 is a flowchart of another embodiment of a message sending method according to the present invention;

FIG. 5 is a flowchart of still another embodiment of a message sending method according to the present invention;

FIG. 6 is a schematic diagram of an embodiment of an application scenario according to the present invention;

FIG. 7 is a flowchart of still another embodiment of a message sending method according to the present invention;

FIG. 8 is a schematic diagram of another embodiment of an application scenario according to the present invention;

FIG. 9A, FIG. 9B, and FIG. 9C are a flowchart of still another embodiment of a message sending method according to the present invention;

FIG. 10 is a schematic structural diagram of an embodiment of a client according to the present invention;

FIG. 11 is a schematic structural diagram of another embodiment of a client according to the present invention;

FIG. 12 is a schematic structural diagram of still another embodiment of a client according to the present invention;

FIG. 13 is a schematic structural diagram of still another embodiment of a client according to the present invention;

FIG. 14 is a schematic structural diagram of an embodiment of a server according to the present invention;

FIG. 15 is a schematic structural diagram of another embodiment of a server according to the present invention;

FIG. 16 is a schematic structural diagram of still another embodiment of a server according to the present invention;

FIG. 17 is a schematic structural diagram of still another embodiment of a client according to the present invention;

FIG. 18 is a schematic structural diagram of still another embodiment of a client according to the present invention;

FIG. 19 is a schematic structural diagram of still another embodiment of a server according to the present invention;

FIG. 20 is a schematic structural diagram of still another embodiment of a server according to the present invention;

FIG. 21 is a schematic structural diagram of an embodiment of a message exchange system according to the present invention; and

FIG. 22 is a schematic structural diagram of another embodiment of a message exchange system according to the present invention.

### DETAILED DESCRIPTION

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are a part rather than all of the embodiments of the present invention. All other embodiments obtained by persons of ordinary skill in the art based on the embodiments of the present invention without creative efforts shall fall within the protection scope of the present invention.

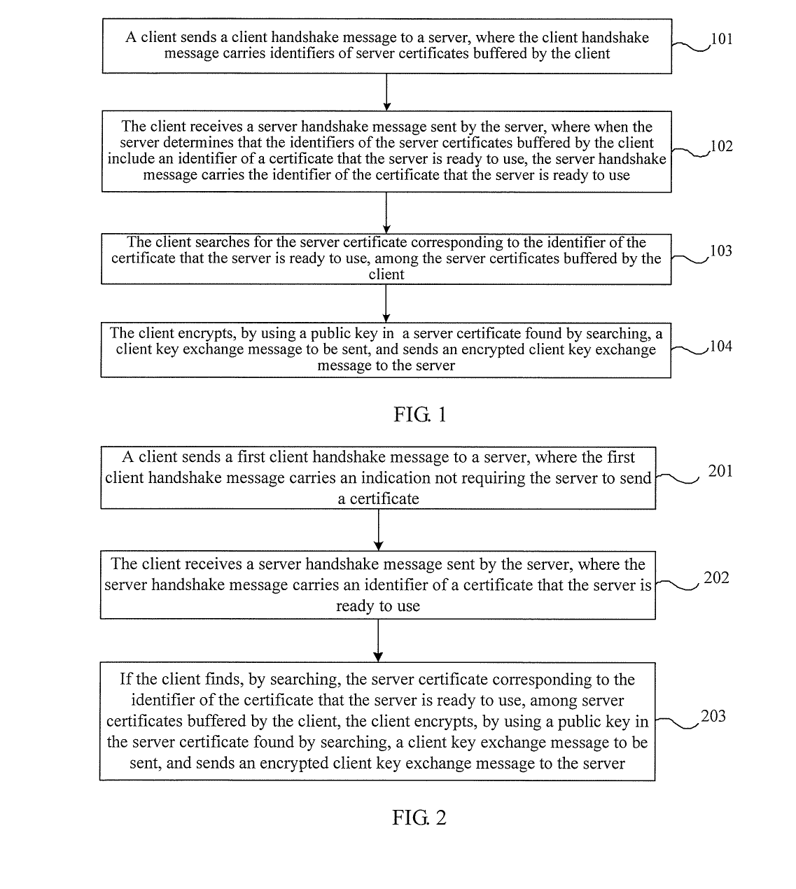

FIG. 1 is a flowchart of an embodiment of a message sending method according to the present invention. As shown in FIG. 1, the message sending method may include:

Step 101: A client sends a client handshake message to a server, where the client handshake message carries identifiers of server certificates buffered by the client.

Specifically, that the client handshake message carries identifiers of server certificates buffered by the client may be that: a first extension is added to the client handshake message, where extension data in the first extension is the identifiers of the server certificates buffered by the client.

Further, the client handshake message may further carry an indication of not requiring the server to send a certificate. Specifically, that the client handshake message may further carry an indication of not requiring the server to send a certificate may be that: an extension type of the first extension added to the client handshake message is not requiring the server to send a certificate.

In specific implementation, the identifiers of the server certificates buffered by the client may be carried in the client handshake message in a form of a list, that is, the extension data in the first extension may be a list of the identifiers of the server certificates buffered by the client. Certainly, the present invention is not limited to this. The identifiers of the server certificates buffered by the client may also be carried in the client handshake message in a form of a chain or an array, which is not limited by the present invention.

Step 102: The client receives a server handshake message sent by the server, where when the server determines that the identifiers of the server certificates buffered by the client include an identifier of a certificate that the server is ready to use, the server handshake message carries the identifier of the certificate that the server is ready to use.

Specifically, that the server handshake message carries the identifier of the certificate that the server is ready to use may be that: a second extension of Certificate Not Required is added to the server handshake message, where extension data in the second extension is the identifier of the certificate that the server is ready to use.

Step 103: The client searches for the server certificate corresponding to the identifier of the certificate that the server is ready to use, among the server certificates buffered by the client.

Step 104: The client encrypts, by using a public key in a server certificate found by searching, a client key exchange message to be sent, and sends an encrypted client key exchange message to the server.

Further, before step 101, the client may further buffer, in a process of interaction with the server, the server certificates sent by the server.

Further, before step 101, the client further needs to check validity of the server certificates buffered by the client; the identifiers that are of the server certificates buffered by the client and are carried in the client handshake message include identifiers of valid server certificates buffered by the client. That is, before sending the client handshake message, the client checks validity of the server certificates buffered by the client, and sends the client handshake message, which carries the identifiers of the valid server certificates buffered by the client, to the server.

In an implementation manner of this embodiment, when the server determines that the identifiers of the server certificates buffered by the client do not include the identifier of the certificate that the server is ready to use, the server handshake message does not carry the identifier of the certificate that the server is ready to use; in this way, after the client receives the server handshake message sent by the server, the client further needs to receive a certificate message sent by the server, where the certificate message sent by the server carries the server certificate that the server is ready to use; and then, the client buffers the server certificate that the server is ready to use, and encrypts, by using the public key in the server certificate that the server is ready to use, the client key exchange message to be sent, and sends the encrypted client key exchange message to the server.

In another implementation manner of this embodiment, the server handshake message may further carry an indication of not requiring the client to send a certificate and carry identifiers of client certificates buffered by the server, in addition to the identifier of the certificate that the server is ready to use. Specifically, when the server needs to perform authentication for the client, the server handshake message may carry the identifier of the certificate that the server is ready to use, the indication of not requiring the client to send a certificate, and the identifiers of the client certificates buffered by the server; thereby, after the client receives the server handshake message sent by the server, the client may further receive a certificate request message sent by the server; when the client determines that the identifiers of the client certificates buffered by the server include an identifier of a certificate that the client is ready to use, the client may send a certificate identifier message to the server according to the certificate request message sent by the server, where the certificate identifier message carries the identifier of the certificate that the client is ready to use; and then, the client encrypts, by using a private key that matches the certificate that the client is ready to use, a certificate verification message to be sent, and sends an encrypted certificate verification message to the server, so that after the server finds, by searching, the client certificate corresponding to the identifier of the certificate that the client is ready to use, among the client certificates buffered by the server, the server decrypts the encrypted certificate verification message by using a public key in the client certificate found by searching, so as to verify an identity of the client.

In this implementation manner, after the client receives the certificate request message sent by the server, when the client determines that the identifiers of the client certificates buffered by the server do not include the identifier of the certificate that the client is ready to use, the client may send a certificate message to the server according to the certificate request message sent by the server, where the certificate message sent by the client carries the client certificate that the client is ready to use; and then, the client encrypts, by using the private key that matches the certificate that the client is ready to use, the certificate verification message to be sent, and sends the encrypted certificate verification message to the server, so that the server decrypts the encrypted certificate verification message by using the public key in the received client certificate, so as to verify the identity of the client.

In this implementation manner, that the server handshake message may further carry an indication of not requiring the client to send a certificate and carry identifiers of client certificates buffered by the server may be that: a third extension of Certificate Not Required is added to the server handshake message, where an extension type of the third extension is not requiring the client to send a certificate, and extension data in the third extension is the identifiers of the client certificates buffered by the server. In specific implementation, the identifiers of the client certificates buffered by the server may be carried in the server handshake message in a form of a list, that is, the extension data in the third extension in the server handshake message may be a list of the identifiers of the client certificates buffered by the server. Certainly, the present invention is not limited to this. The identifiers of the client certificates buffered by the server may also be carried in the server handshake message in a form of a chain or an array, which is not limited by the present invention.

In still another implementation manner of this embodiment, the server handshake message may further carry only an indication of not requiring the client to send a certificate, in addition to the identifier of the certificate that the server is ready to use, but does not carry identifiers of client certificates buffered by the server. Specifically, when the server needs to perform authentication for the client, the server handshake message may carry the identifier of the certificate that the server is ready to use, and the indication of not requiring the client to send a certificate. In this way, after the client receives the server handshake message sent by the server, the client may further receive a certificate request message sent by the server, and then send a certificate identifier message to the server, where the certificate identifier message carries an identifier of a certificate that the client is ready to use; and then, the client encrypts, by using a private key that matches the certificate that the client is ready to use, a certificate verification message to be sent, and sends an encrypted certificate verification message to the server, so that after the server finds, by searching, the client certificate corresponding to the identifier of the certificate that the client is ready to use, among the client certificates buffered by the server, the server decrypts the encrypted certificate verification message by using a public key in the client certificate found by searching, so as to verify an identity of the client.

If the server does not find, by searching, the client certificate corresponding to the identifier of the certificate that the client is ready to use, among the client certificates buffered by the server, the server may send an authentication failure response message to the client, where the authentication failure response message carries an authentication failure cause, where the authentication failure cause is that the server does not find, by searching, the client certificate corresponding to the identifier of the certificate that the client is ready to use, among the client certificates buffered by the server; or the server may send a handshake failure message to the client.

After receiving the authentication failure response message or the handshake failure message, the client sends a client handshake message to the server again, where the client handshake message that is sent again carries the indication of not requiring the server to send a certificate and carries the identifiers of the server certificates buffered by the client; then the server sends a server handshake message to the client again, where the server handshake message that is sent again carries the identifier of the certificate that the server is ready to use, but does not carry the indication of not requiring the client to send a certificate. After sending the server handshake message, the server sends a certificate request message to the client, and then, the client sends a certificate message to the server, where the certificate message sent by the client carries the client certificate that the client is ready to use; then, the client encrypts, by using a private key of the client, the certificate verification message to be sent, and sends the encrypted certificate verification message to the server, so that the server decrypts the encrypted certificate verification message by using the public key in the received client certificate, so as to verify the identity of the client.

In this implementation manner, that the server handshake message may further carry an indication of not requiring the client to send a certificate may be that: a fourth extension of Certificate Not Required is added to the server handshake message, where an extension type of the fourth extension is not requiring the client to send a certificate.

In this embodiment, a client sends a client handshake message, which carries identifiers of server certificates buffered by the client, to a server; when the server determines that the identifiers of the server certificates buffered by the client include an identifier of a certificate that the server is ready to use, the server may not send a certificate message, but sends a server handshake message, which carries the identifier of the certificate that the server is ready to use, to the client; and then the client searches for the server certificate corresponding to the identifier of the certificate that the server is ready to use, among the server certificates buffered by the client, and encrypts, by using a public key in a server certificate found by searching, a client key exchange message to be sent, and sends an encrypted client key exchange message to the server. In this embodiment, the server may not send a certificate message to the client, which may reduce an amount of data in a TLS handshake process and shorten a time occupied by the TLS handshake process, and may further improve a TLS connection speed, and may avoid a problem that a certificate message is sent for multiple times due to an excessively small buffer size, and thereby may further improve the TLS connection speed.

FIG. 2 is a flowchart of another embodiment of a message sending method according to the present invention. As shown in FIG. 2, the message sending method may include:

Step 201: A client sends a first client handshake message to a server, where the first client handshake message carries an indication of not requiring the server to send a certificate.

Specifically, that the first client handshake message carries an indication of not requiring the server to send a certificate may be that: a first extension is added to the first client handshake message, where an extension type of the first extension is not requiring the server to send a certificate.

Step 202: The client receives a server handshake message sent by the server, where the server handshake message carries an identifier of a certificate that the server is ready to use.

Specifically, that the server handshake message carries an identifier of a certificate that the server is ready to use may be that: a second extension is added to the server handshake message, where extension data in the second extension is the identifier of the certificate that the server is ready to use.

Step 203: If the client finds, by searching, the server certificate corresponding to the identifier of the certificate that the server is ready to use, among server certificates buffered by the client, the client encrypts, by using a public key in the server certificate found by searching, a client key exchange message to be sent, and sends an encrypted client key exchange message to the server.

In an implementation manner of this embodiment, after step 202, if the client does not find, by searching, the server certificate corresponding to the identifier of the certificate that the server is ready to use, among the server certificates buffered by the client, the client sends a second client handshake message to the server, where the second client handshake message does not carry the indication of not requiring the server to send a certificate; then, the client receives a certificate message sent by the server, where the certificate message sent by the server carries the server certificate that the server is ready to use; and the client buffers the server certificate that the server is ready to use, and encrypts, by using the public key in the server certificate, the client key exchange message to be sent, and sends the encrypted client key exchange message to the server.

In the foregoing embodiment, a client sends a first client handshake message, which carries an indication of not requiring a server to send a certificate, to the server; after receiving the first client handshake message, the server does not send a certificate message, but sends a server handshake message, which carries an identifier of a certificate that the server is ready to use, to the client; and if the client finds, by searching, the server certificate corresponding to the identifier of the certificate that the server is ready to use, among server certificates buffered by the client, the client may encrypt, by using a public key in the server certificate found by searching, a client key exchange message to be sent, and send an encrypted client key exchange message to the server. In this embodiment, the server may not send a certificate message to the client, which may reduce an amount of data in a TLS handshake process and shorten a time occupied by the TLS handshake process, and may further improve a TLS connection speed, and may avoid a problem that a certificate message is sent for multiple times due to an excessively small buffer size, and thereby may further improve the TLS connection speed.

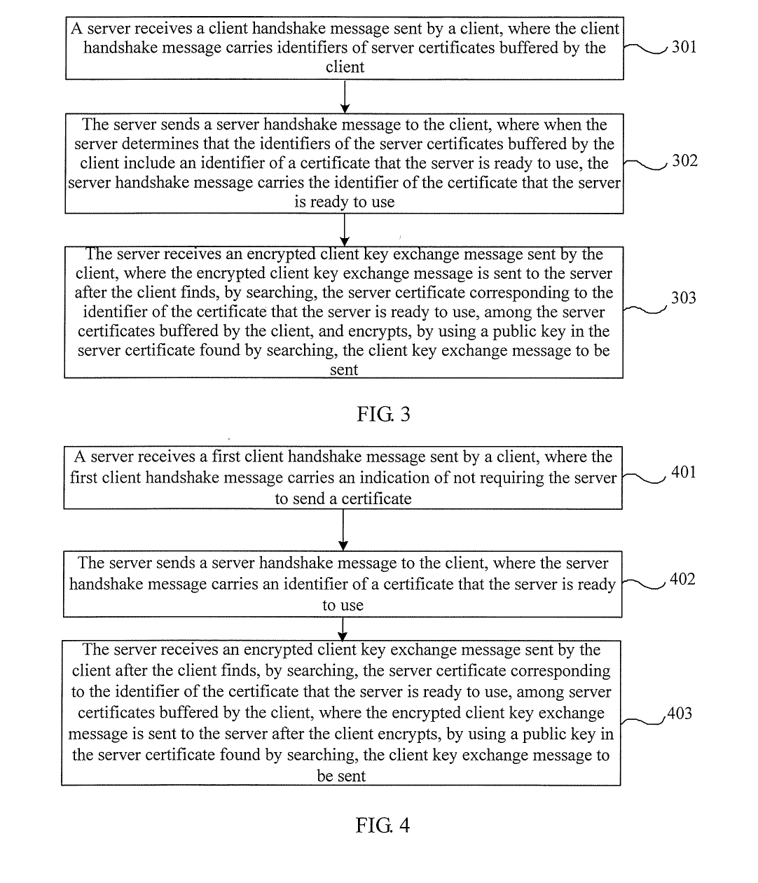

FIG. 3 is a flowchart of still another embodiment of a message sending method according to the present invention. As shown in FIG. 3, the message sending method may include:

Step 301: A server receives a client handshake message sent by a client, where the client handshake message carries identifiers of server certificates buffered by the client.

The identifiers that are of the server certificates buffered by the client and are carried in the client handshake message include identifiers of valid server certificates buffered by the client. That is, before sending the client handshake message, the client checks validity of the server certificates buffered by the client, and sends the client handshake message, which carries the identifiers of the valid server certificates buffered by the client, to the server.

Specifically, that the client handshake message carries identifiers of server certificates buffered by the client may be that: a first extension is added to the client handshake message, where extension data in the first extension is the identifiers of the server certificates buffered by the client.

Further, the client handshake message may further carry an indication of not requiring the server to send a certificate. Specifically, that the client handshake message may further carry an indication of not requiring the server to send a certificate may be that: an extension type of the first extension added to the client handshake message is not requiring the server to send a certificate.

In specific implementation, the identifiers of the server certificates buffered by the client may be carried in the client handshake message in a form of a list, that is, the extension data in the first extension in the client handshake message may be a list of the identifiers of the server certificates buffered by the client. Certainly, the present invention is not limited to this. The identifiers of the server certificates buffered by the client may also be carried in the client handshake message in a form of a chain or an array, which is not limited by the present invention.

Step 302: The server sends a server handshake message to the client, where when the server determines that the identifiers of the server certificates buffered by the client include an identifier of a certificate that the server is ready to use, the server handshake message carries the identifier of the certificate that the server is ready to use.

Specifically, that the server handshake message carries the identifier of the certificate that the server is ready to use may be that: a second extension of Certificate Not Required is added to the server handshake message, where extension data in the second extension is the identifier of the certificate that the server is ready to use.

Step 303: The server receives an encrypted client key exchange message sent by the client, where the encrypted client key exchange message is sent to the server after the client finds, by searching, the server certificate corresponding to the identifier of the certificate that the server is ready to use, among the server certificates buffered by the client, and encrypts, by using a public key in the server certificate found by searching, the client key exchange message to be sent.

Further, before step 301, the server may further send the server certificates to the client in a process of interaction with the client, so that the client buffers the server certificates sent by the server.

In an implementation manner of this embodiment, when the server determines that the identifiers of the server certificates buffered by the client do not include the identifier of the certificate that the server is ready to use, the server handshake message does not carry the identifier of the certificate that the server is ready to use; in this way, after the server sends the server handshake message to the client, the server sends a certificate message to the client, where the certificate message sent by the server carries the server certificate that the server is ready to use, so that the client buffers the server certificate that the server is ready to use; and then, the server receives the encrypted client key exchange message sent by the client, where the encrypted client key exchange message is sent to the server after the client receives the server certificate that the server is ready to use, and encrypts, by using the public key in the server certificate that the server is ready to use, the client key exchange message to be sent.

In another implementation manner of this embodiment, the server handshake message may further carry an indication of not requiring the client to send a certificate and carry identifiers of client certificates buffered by the server, in addition to the identifier of the certificate that the server is ready to use. Specifically, when the server needs to perform authentication for the client, the server handshake message may carry the identifier of the certificate that the server is ready to use, the indication of not requiring the client to send a certificate, and the identifiers of the client certificates buffered by the server. In this implementation manner, after the server sends the server handshake message to the client, the server may further send a certificate request message to the client; then, the server receives a certificate identifier message that is sent by the client after the client determines that the identifiers of the client certificates buffered by the server include an identifier of a certificate that the client is ready to use, where the certificate identifier message carries the identifier of the certificate that the client is ready to use; and finally, the server receives an encrypted certificate verification message sent by the client, where the encrypted certificate verification message is sent to the server after the client encrypts, by using a private key that matches the certificate that the client is ready to use, the certificate verification message to be sent; after the server finds, by searching, the client certificate corresponding to the identifier of the certificate that the client is ready to use, among the client certificates buffered by the server, the server decrypts the encrypted certificate verification message by using a public key in the client certificate found by searching, so as to verify an identity of the client.

In this implementation manner, after the server sends the certificate request message to the client, the server may further receive a certificate message that is sent by the client after the client determines that the identifiers of the client certificates buffered by the server do not include the identifier of the certificate that the client is ready to use, where the certificate message sent by the client carries the client certificate that the client is ready to use; then, the server receives the encrypted certificate verification message sent by the client, where the encrypted certificate verification message is sent to the server after the client encrypts, by using the private key that matches the certificate that the client is ready to use, the certificate verification message to be sent; and finally, the server decrypts the encrypted certificate verification message by using the public key in the received client certificate, so as to verify the identity of the client.

In this implementation manner, that the server handshake message may further carry an indication of not requiring the client to send a certificate and carry identifiers of client certificates buffered by the server may be that: a third extension of Certificate Not Required is added to the server handshake message, where an extension type of the third extension is not requiring the client to send a certificate, and extension data in the third extension is the identifiers of the client certificates buffered by the server. In specific implementation, the identifiers of the client certificates buffered by the server may be carried in the server handshake message in a form of a list, that is, the extension data in the third extension in the server handshake message may be a list of the identifiers of the client certificates buffered by the server. Certainly, the present invention is not limited to this. The identifiers of the client certificates buffered by the server may also be carried in the server handshake message in a form of a chain or an array, which is not limited by the present invention.

In still another implementation manner of this embodiment, the server handshake message may further carry only an indication of not requiring the client to send a certificate, in addition to the identifier of the certificate that the server is ready to use, but does not carry identifiers of client certificates buffered by the server. Specifically, when the server needs to perform authentication for the client, the server handshake message may carry the identifier of the certificate that the server is ready to use, and the indication of not requiring the client to send a certificate. In this way, after the server sends the server handshake message to the client, the server may further send a certificate request message to the client, and then the server receives a certificate identifier message sent by the client, where the certificate identifier message carries an identifier of a certificate that the client is ready to use; then, the server receives an encrypted certificate verification message sent by the client, where the encrypted certificate verification message is sent to the server after the client encrypts, by using a private key that matches the certificate that the client is ready to use, the certificate verification message to be sent; and finally, after the server finds, by searching, the client certificate corresponding to the identifier of the certificate that the client is ready to use, among the client certificates buffered by the server, the server decrypts the encrypted certificate verification message by using a public key in the client certificate found by searching, so as to verify an identity of the client.

If the server does not find, by searching, the client certificate corresponding to the identifier of the certificate that the client is ready to use, among the client certificates buffered by the server, the server may send an authentication failure response message to the client, where the authentication failure response message carries an authentication failure cause, where the authentication failure cause is that the server does not find, by searching, the client certificate corresponding to the identifier of the certificate that the client is ready to use, among the client certificates buffered by the server; or the server may send a handshake failure message to the client.

After receiving the authentication failure response message or the handshake failure message, the client sends a client handshake message to the server, where the client handshake message that is sent again carries the indication of not requiring the server to send a certificate and carries the identifiers of the server certificates buffered by the client; then the server sends a server handshake message to the client again, where the server handshake message that is sent again carries the identifier of the certificate that the server is ready to use, but does not carry the indication of not requiring the client to send a certificate. After sending the server handshake message, the server sends a certificate request message to the client, and then, the client sends a certificate message to the server, where the certificate message sent by the client carries the client certificate that the client is ready to use; then, the client encrypts, by using a private key of the client, the certificate verification message to be sent, and sends the encrypted certificate verification message to the server, so that the server decrypts the encrypted certificate verification message by using the public key in the received client certificate, so as to verify the identity of the client.

In this implementation manner, that the server handshake message may further carry an indication of not requiring the client to send a certificate may be that: a fourth extension of Certificate Not Required is added to the server handshake message, where an extension type of the fourth extension is not requiring the client to send a certificate.

In the foregoing embodiment, after a server receives a client handshake message sent by a client and carrying identifiers of server certificates buffered by the client, when the server determines that the identifiers of the server certificates buffered by the client include an identifier of a certificate that the server is ready to use, the server may not send a certificate message, but sends a server handshake message, which carries the identifier of the certificate that the server is ready to use, to the client. In this embodiment, the server may not send a certificate message to the client, which may reduce an amount of data in a TLS handshake process and shorten a time occupied by the TLS handshake process, and may further improve a TLS connection speed, and may avoid a problem that a certificate message is sent for multiple times due to an excessively small buffer size, and thereby may further improve the TLS connection speed.

FIG. 4 is a flowchart of still another embodiment of a message sending method according to the present invention. As shown in FIG. 4, the message sending method may include:

Step 401: A server receives a first client handshake message sent by a client, where the first client handshake message carries an indication of not requiring the server to send a certificate.

Specifically, that the first client handshake message carries an indication of not requiring the server to send a certificate may be that: a first extension is added to the first client handshake message, where an extension type of the first extension is not requiring the server to send a certificate.

Step 402: The server sends a server handshake message to the client, where the server handshake message carries an identifier of a certificate that the server is ready to use.

Specifically, that the server handshake message carries an identifier of a certificate that the server is ready to use may be that: a second extension is added to the server handshake message, where extension data in the second extension is the identifier of the certificate that the server is ready to use.

Step 403: The server receives an encrypted client key exchange message sent by the client after the client finds, by searching, the server certificate corresponding to the identifier of the certificate that the server is ready to use, among server certificates buffered by the client, where the encrypted client key exchange message is sent to the server after the client encrypts, by using a public key in the server certificate found by searching, the client key exchange message to be sent.

In an implementation manner of this embodiment, after step 402, the server may further receive a second client handshake message that is sent by the client after the client does not find, by searching, the server certificate corresponding to the identifier of the certificate that the server is ready to use, among the server certificates buffered by the client, where the second client handshake message does not carry the indication of not requiring the server to send a certificate; then, the server sends a certificate message to the client, where the certificate message sent by the server carries the server certificate that the server is ready to use, so that the client buffers the server certificate that the server is ready to use. Then, the server receives the encrypted client key exchange message sent by the client, where the encrypted client key exchange message is sent to the server after the client receives the server certificate that the server is ready to use, and encrypts, by using the public key in the server certificate, the client key exchange message to be sent.

In the foregoing embodiment, after a server receives a first client handshake message sent by a client and carrying an indication of not requiring the server to send a certificate, the server does not send a certificate message to the client, but sends a server handshake message, which carries an identifier of a certificate that the server is ready to use, to the client. In this embodiment, the server may not send a certificate message to the client, which may reduce an amount of data in a TLS handshake process and shorten a time occupied by the TLS handshake process, and may further improve a TLS connection speed, and may avoid a problem that a certificate message is sent for multiple times due to an excessively small buffer size, and thereby may further improve the TLS connection speed.

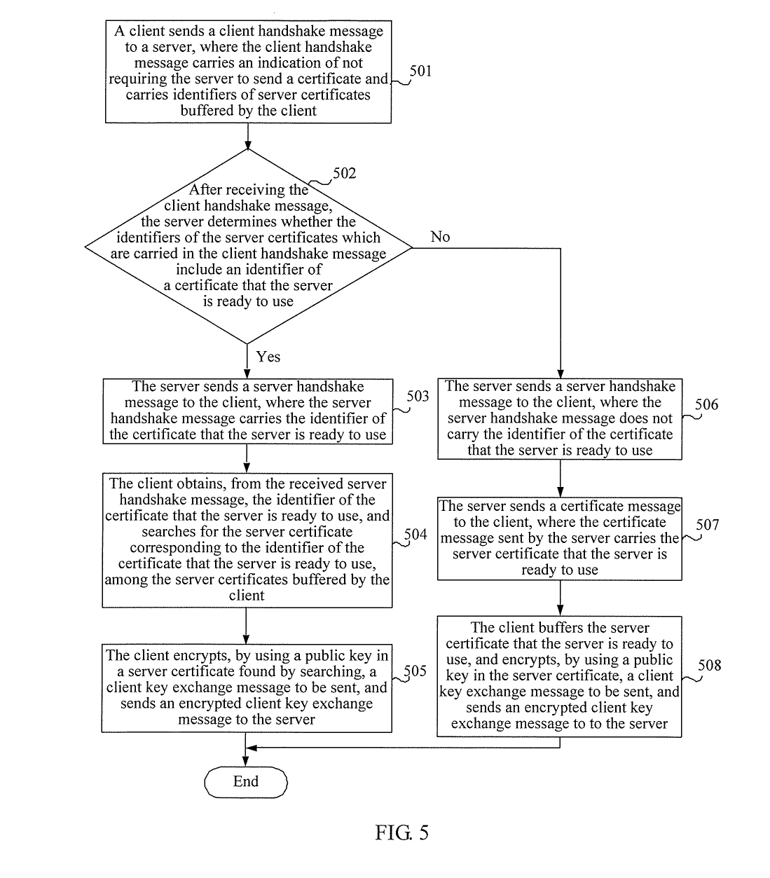

FIG. 5 is a flowchart of still another embodiment of a message sending method according to the present invention. As shown in FIG. 5, the message sending method may include:

Step 501: A client sends a client handshake (ClientHello) message to a server, where the client handshake message carries an indication of not requiring the server to send a certificate and carries identifiers of server certificates buffered by the client.

In this embodiment, before the client sends the client handshake message to the server, the client buffers, in a process of interaction with the server, some server certificates that are sent in a certificate (Certificate) message.

Then, the client sends a client handshake message, which carries identifiers of the server certificates buffered by the client, to the server, and at the same time, the client handshake message carries the indication of not requiring the server to send a certificate.

Specifically, that the client handshake message carries an indication of not requiring the server to send a certificate and carries identifiers of server certificates buffered by the client may be that: a first extension is added to the client handshake message, where the first extension may be an extension of Certificate Not Required (Certificate Not Required), an extension type of the first extension is not requiring the server to send a certificate, and extension data in the first extension is the identifiers of the server certificates buffered by the client.

In specific implementation, the identifiers of the server certificates buffered by the client may be carried in the client handshake message in a form of a list, that is, the extension data in the first extension added to the client handshake message may be a list of the identifiers of the server certificates buffered by the client. Certainly, the present invention is not limited to this. The identifiers of the server certificates buffered by the client may also be carried in the client handshake message in a form of a chain or an array, which is not limited by the present invention.

Preferably, before the client sends the client handshake message, the client needs to check whether the server certificates buffered by the client are valid, that is, check validity of the server certificates buffered by the client; and sends the client handshake message, which carries only identifiers of valid server certificates buffered by the client, to the server. Specifically, because the client stores the buffered server certificates locally, and the buffered server certificates have passed verification, the client only needs to check a time-related constraint, including whether the server certificates are still within a validity period, whether the server certificates are revoked by a certificate revocation list (Certificate Revocation List, CRL for short) or an Online Certificate Status Protocol (Online Certificate Status Protocol, OCSP for short). If the client buffers many server certificates, validity check performed for the server certificates causes a certain overhead. In this case, some optimization measures may be adopted, for example, classifying the buffered server certificates, and when a connection is established to a type of server, only sending identifiers of server certificates of this type of server; or optimizing a quantity of buffered server certificates; or using a separate thread or process to periodically detect and refresh statuses of server certificates; or checking all buffered server certificates when the CRL is loaded, and removing revoked server certificates.

Step 502: After receiving the client handshake message, the server determines whether the identifiers of the server certificates which are carried in the client handshake message include an identifier of a certificate that the server is ready to use. If yes, step 503 is performed; and if the identifiers of the server certificates which are carried in the client handshake message do not include the identifier of the certificate that the server is ready to use, step 506 is performed.

Step 503: The server sends a server handshake (ServerHello) message to the client, where the server handshake message carries the identifier of the certificate that the server is ready to use.

Specifically, that the server handshake message carries the identifier of the certificate that the server is ready to use may be that: a second extension is added to the server handshake message, where the second extension may be an extension of Certificate Not Required, where extension data in the second extension is the identifier of the certificate that the server is ready to use.

Step 504: The client obtains, from the received server handshake message, the identifier of the certificate that the server is ready to use, and searches for the server certificate corresponding to the identifier of the certificate that the server is ready to use, among the server certificates buffered by the client.

Step 505: The client encrypts, by using a public key in a server certificate found by searching, a client key exchange message to be sent, and sends an encrypted client key exchange message to the server. The procedure ends.

Step 506: The server sends a server handshake message to the client, where the server handshake message does not carry the identifier of the certificate that the server is ready to use.

Step 507: The server sends a certificate message to the client, where the certificate message sent by the server carries the server certificate that the server is ready to use.

Step 508: The client buffers the server certificate that the server is ready to use, and encrypts, by using a public key in the server certificate, a client key exchange message to be sent, and sends an encrypted client key exchange message to the server. The procedure ends.

That is, when the identifiers of the server certificates which are carried in the client handshake message do not include the identifier of the certificate that the server is ready to use, the server handshake message sent by the server to the client does not carry the identifier of the certificate that the server is ready to use, and the server needs to send a certificate message to the client, where the certificate message carries the server certificate that the server is ready to use; after receiving the certificate message sent by the server, the client buffers the certificate that the server is ready to use, and encrypts, by using the public key in the server certificate, the client key exchange message to be sent, and sends the encrypted client key exchange message to the server.

In the foregoing embodiment, when identifiers of server certificates which are carried in a client handshake message include an identifier of a certificate that a server is ready to use, the server may not send a certificate message to a client, which may reduce an amount of data in a TLS handshake process and shorten a time occupied by the TLS handshake process, and may further improve a TLS connection speed, and may avoid a problem that a certificate message is sent for multiple times due to an excessively small buffer size, and thereby may further improve the TLS connection speed. In addition, omitting certificate message sending may omit a process of verifying a certificate by the client, and thereby may greatly reduce central processing unit (Central Processing Unit, CPU for short) overheads of the client in the TLS handshake process.

It should be noted that in the embodiments shown in FIG. 1, FIG. 3, and FIG. 5, when the client interacts with a server for the first time, or the server certificates buffered by the client are invalid, the server cannot find the identifier of the certificate that the server is ready to use, among the identifiers of the server certificates which are carried in the client handshake message. In this case, the server needs to send a certificate message. In addition, when the client accesses a network for the first time and does not buffer any certificate, the client handshake message sent by the client neither carries the indication of not requiring the server to send a certificate, nor carries the identifiers of the server certificates buffered by the client; that is, the client handshake message sent by the client does not carry the extension of Certificate Not Required.

According to an existing extension mechanism of TLS, if the server cannot identify the extension of Certificate Not Required (Certificate Not Required), which is added to the client handshake message, the server may directly ignore the extension and send a certificate message. Likewise, if the client finds, by searching, that the server does not respond, in the server handshake message, to the added extension of Certificate Not Required, the client may still continue to process the certificate message. Therefore, the method provided by the present invention does not affect interoperability.

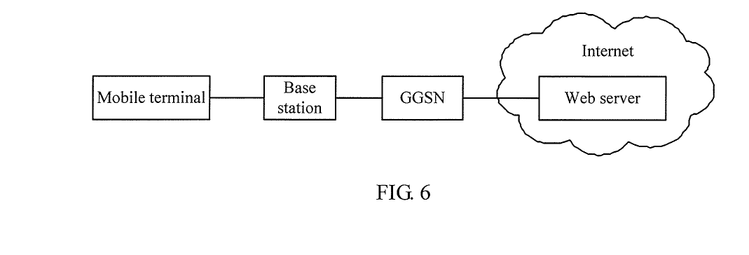

The embodiments shown in FIG. 1, FIG. 3, and FIG. 5 of the present invention may be applied to an application scenario shown in FIG. 6. FIG. 6 is a schematic diagram of an embodiment of an application scenario according to the present invention. As shown in FIG. 6, a mobile terminal is connected to a Web server on the Internet through a base station and a gateway general packet radio service support node (Gateway General Packet Radio Service Support Node, GGSN for short).

Generally, a bandwidth of a general packet radio service (General Packet Radio Service, GPRS for short) channel is very low. In a process of establishing an end-to-end TLS connection to the Web server by the mobile terminal, reduction of sending certificate messages may greatly improve a speed of establishing the TLS connection between the mobile terminal and the Web server.

When a user using the mobile terminal browses a website, generally the user accesses some websites repeatedly. In this case, the method provided by the present invention may greatly improve a speed of connecting to the websites that are accessed repeatedly. In addition, when the user accesses a website, for different pages on the website, some new connections may be initiated sometimes. In this case, the method provided by the present invention may also improve performance, and thereby improve user experience.

In addition, because some mobile terminals have few CPU resources, the method provided by the present invention may reduce CPU overheads required for verifying a server certificate, and may also greatly improve TLS connection performance of the mobile terminal.

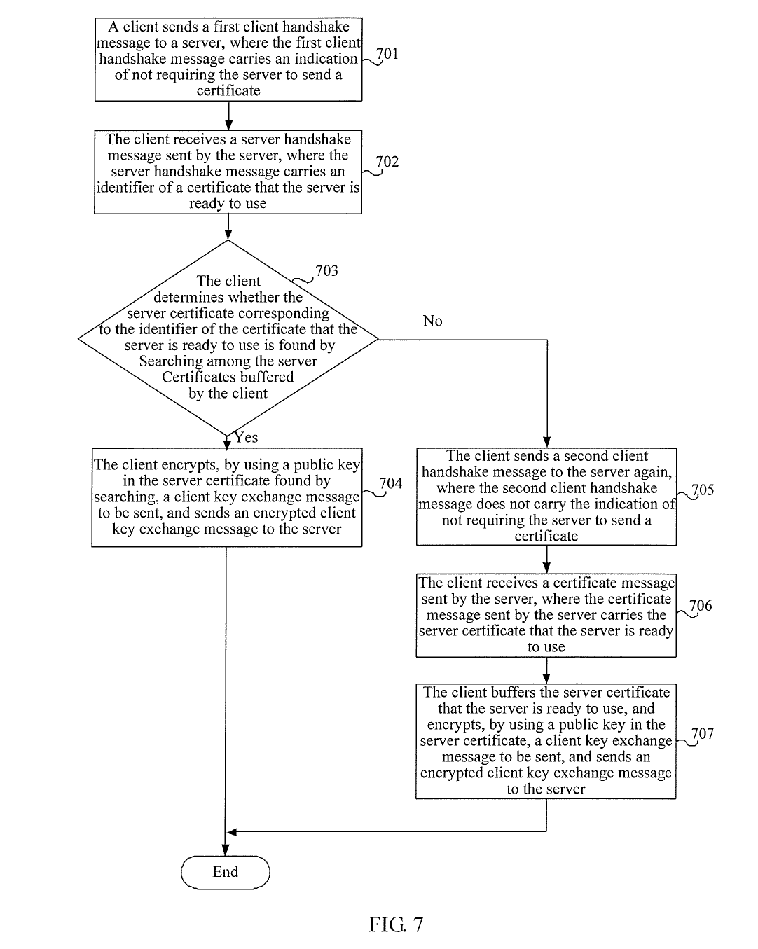

FIG. 7 is a flowchart of still another embodiment of a message sending method according to the present invention. As shown in FIG. 7, the message sending method may include:

Step 701: A client sends a first client handshake message to a server, where the first client handshake message carries an indication of not requiring the server to send a certificate.

Specifically, that the first client handshake message carries an indication of not requiring the server to send a certificate may be that: a first extension is added to the first client handshake message, where the first extension may be an extension of Certificate Not Required, and an extension type of the first extension is not requiring the server to send a certificate.

In this embodiment, extension data in the first extension added to the first client handshake message carries an identifier of 0 server certificate, so as to indirectly indicate that the client buffers server certificates.

Step 702: The client receives a server handshake message sent by the server, where the server handshake message carries an identifier of a certificate that the server is ready to use.

Specifically, that the server handshake message carries an identifier of a certificate that the server is ready to use may be that: a second extension is added to the server handshake message, where the second extension may be an extension of Certificate Not Required, where extension data in the second extension is the identifier of the certificate that the server is ready to use.

Step 703: The client determines whether the server certificate corresponding to the identifier of the certificate that the server is ready to use is found by searching among the server certificates buffered by the client. If yes, step 704 is performed; and if the client does not find, by searching, the server certificate corresponding to the identifier of the certificate that the server is ready to use, among the server certificates buffered by the client, step 705 is performed.

Step 704: The client encrypts, by using a public key in the server certificate found by searching, a client key exchange message to be sent, and sends an encrypted client key exchange message to the server. The procedure ends.

Step 705: The client sends a second client handshake message to the server again, where the second client handshake message does not carry the indication of not requiring the server to send a certificate.

Step 706: The client receives a certificate message sent by the server, where the certificate message sent by the server carries the server certificate that the server is ready to use.

Step 707: The client buffers the server certificate that the server is ready to use, and encrypts, by using a public key in the server certificate, a client key exchange message to be sent, and sends an encrypted client key exchange message to the server. The procedure ends.

In the foregoing embodiment, when a first client handshake message carries an indication of not requiring a server to send a certificate, the server may not send a certificate message to a client, which may reduce an amount of data in a TLS handshake process and shorten a time occupied by the TLS handshake process, and may further improve a TLS connection speed, and may avoid a problem that a certificate message is sent for multiple times due to an excessively small buffer size, and thereby may further improve the TLS connection speed. In addition, omitting certificate message sending may omit a process of verifying a certificate by the client, and thereby may greatly reduce CPU overheads of the client in the TLS handshake process. In addition, in the embodiment shown in FIG. 7 of the present invention, the first client handshake message does not carry the identifiers of the server certificates buffered by the client, so that a size of the client handshake message does not increase too much.

The methods provided by the embodiments shown in FIG. 2, FIG. 4, and FIG. 7 of the present invention are applicable to a scenario in which the client always interacts with some fixed servers. Otherwise, because the client does not send the identifiers of the server certificates buffered by the client, and the server considers that the server certificates are already buffered by the client, but actually the client may not have the server certificates. In this case, a handshake fails. At this time, the client needs to re-initiate a message not carrying the indication of not requiring the server to send a certificate, and receive a certificate message sent by the server, and buffer the server certificate that the server is ready to use, which is carried in the certificate message. In this way, authentication is implemented by means of two handshakes.

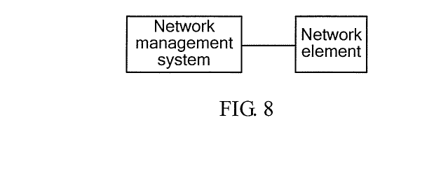

For example, the methods provided by the embodiments shown in FIG. 2, FIG. 4, and FIG. 7 of the present invention may be applied to an application scenario shown in FIG. 8. FIG. 8 is a schematic diagram of another embodiment of an application scenario according to the present invention. As shown in FIG. 8, in a process of establishing a TLS connection between a network management system and a network element, the network management system may be considered as a client, and the network element may be considered as a server. After the network element is added and managed by the network management system, the network management system is connected to some fixed network elements. According to the method provided by the embodiment shown in FIG. 7 of the present invention, in a handshake process, the network management system may send, to the network element, a first handshake message not including an identifier of a certificate, and then the network element sends a handshake message, which carries an identifier of a certificate that the network element is ready to use, to the network management system. If the network management system finds, by searching, the certificate corresponding to the identifier of the certificate that the network element is ready to use, among certificates buffered by the network management system, the network management system may encrypt, by using a public key in the found certificate, a key exchange message to be sent, and send an encrypted key exchange message to the network management system, so as to establish a TLS connection to the network element. In this case, the network management system and the network element may implement authentication by means of a handshake process to quickly establish the TLS connection.

If the network management system does not find, by searching, the certificate corresponding to the identifier of the certificate that the network element is ready to use, among the certificates buffered by the network management system, the network management system may send a second handshake message to the network element, where the second handshake message does not carry an indication of not requiring the network element to send a certificate; after receiving the second handshake message, the network element sends a certificate message to the network management system, where the certificate message carries the certificate that the network element is ready to use; and after receiving the certificate message, the network management system buffers the certificate carried in the certificate message. In this way, when the network management system establishes a TLS connection to the network element again subsequently, authentication may be implemented by means of a handshake process and the TLS connection may be established quickly.

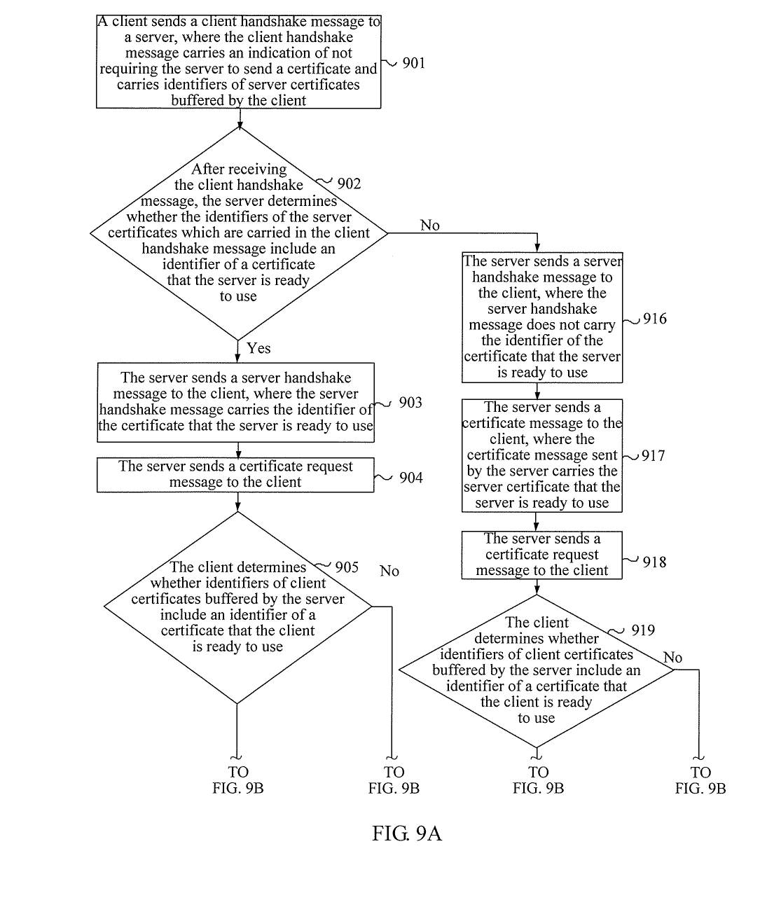

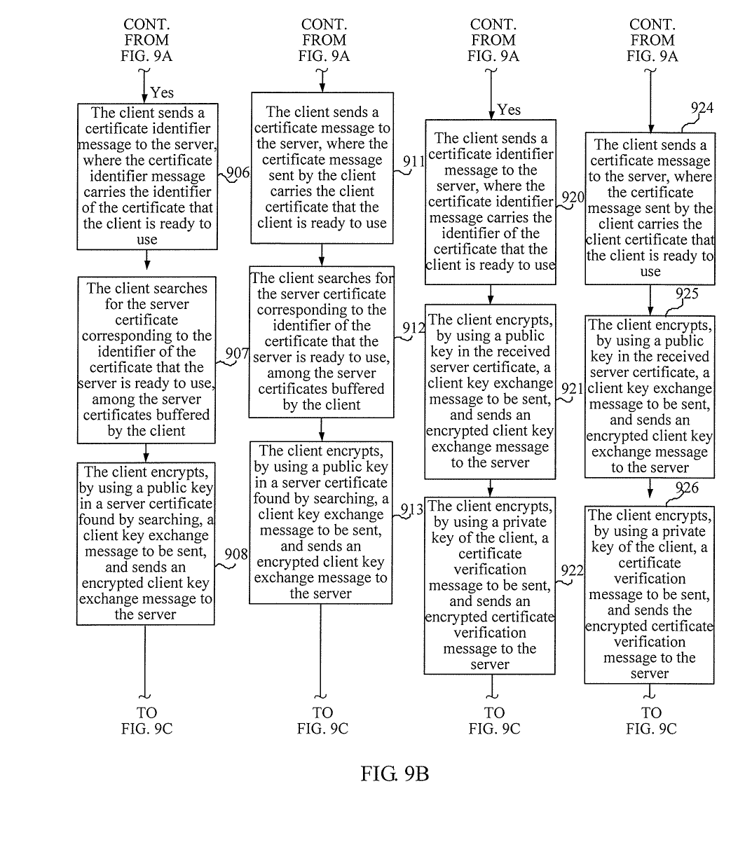

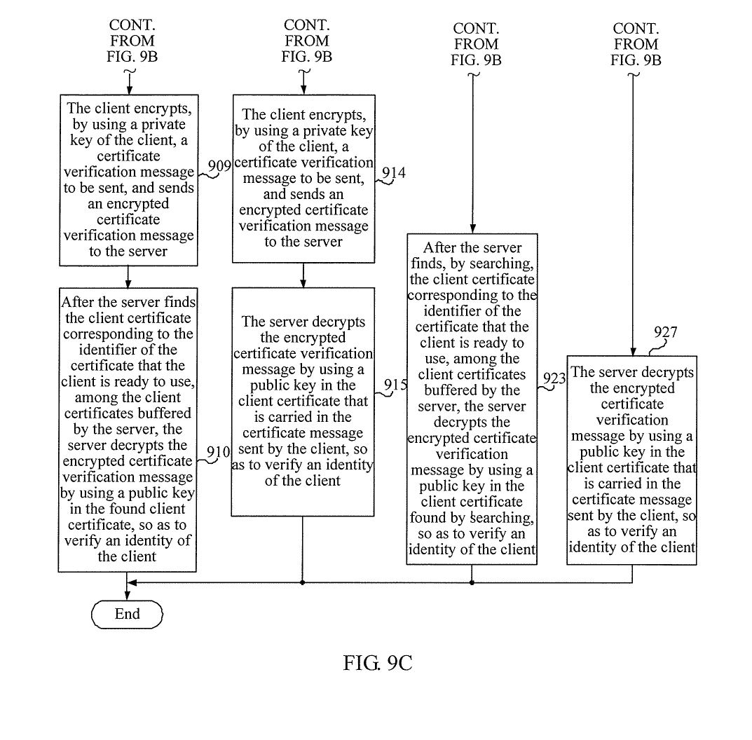

FIG. 9A, FIG. 9B, and FIG. 9C are a flowchart of still another embodiment of a message sending method according to the present invention. As shown in FIG. 9A, FIG. 9B, and FIG. 9C, the message sending method may include:

Step 901: A client sends a client handshake message to a server, where the client handshake message carries an indication of not requiring the server to send a certificate and carries identifiers of server certificates buffered by the client.

In this embodiment, before the client sends the client handshake message to the server, the client buffers, in a process of interaction with the server, some server certificates that are sent in a certificate message.

Then, the client sends a client handshake message, which carries identifiers of the server certificates buffered by the client, to the server, and at the same time, the client handshake message carries the indication of not requiring the server to send a certificate.

Specifically, that the client handshake message carries an indication of not requiring the server to send a certificate and carries identifiers of server certificates buffered by the client may be that: a first extension is added to the client handshake message, where the first extension may be an extension of Certificate Not Required (Certificate Not Required), an extension type of the first extension is not requiring the server to send a certificate, and extension data in the first extension is the identifiers of the server certificates buffered by the client.

In specific implementation, the identifiers of the server certificates buffered by the client may be carried in the client handshake message in a form of a list, that is, the extension data in the first extension added to the client handshake message may be a list of the identifiers of the server certificates buffered by the client. Certainly, the present invention is not limited to this. The identifiers of the server certificates buffered by the client may also be carried in the client handshake message in a form of a chain or an array, which is not limited by the present invention.

Preferably, before the client sends the client handshake message, the client needs to check whether the server certificates buffered by the client are valid, that is, check validity of the server certificates buffered by the client; and sends the client handshake message, which carries only identifiers of valid server certificates buffered by the client, to the server. Specifically, because the client stores the buffered server certificates locally, and the buffered server certificates have passed verification, the client only needs to check a time-related constraint, including whether the server certificates are still within a validity period, and whether the server certificates are revoked by a CRL or OCSP. If the client buffers many server certificates, validity check performed for the server certificates brings a certain overhead. In this case, some optimization measures may be adopted, for example, classifying the buffered server certificates, and when a connection is established to a type of server, only sending identifiers of server certificates of this type of server; or optimizing a quantity of buffered server certificates; or using a separate thread or process to periodically detect and refresh statuses of server certificates; or checking all buffered server certificates when the CRL is loaded, and removing revoked server certificates.

Step 902: After receiving the client handshake message, the server determines whether the identifiers of the server certificates which are carried in the client handshake message include an identifier of a certificate that the server is ready to use. If yes, step 903 is performed; and if the identifiers of the server certificates which are carried in the client handshake message do not include the identifier of the certificate that the server is ready to use, step 916 is performed.

Step 903: The server sends a server handshake message to the client, where the server handshake message carries the identifier of the certificate that the server is ready to use.

Further, when the server needs to perform authentication for the client, the server handshake message may further carry an indication of not requiring the client to send a certificate and carry identifiers of client certificates buffered by the server.

Specifically, that the server handshake message carries the identifier of the certificate that the server is ready to use may be that: a second extension is added to the server handshake message, where the second extension may be an extension of Certificate Not Required, where extension data in the second extension is the identifier of the certificate that the server is ready to use.

That the server handshake message may further carry an indication of not requiring the client to send a certificate and carry identifiers of client certificates buffered by the server may be that: a third extension is added to the server handshake message, where the third extension may be an extension of Certificate Not Required, where an extension type of the third extension is not requiring the client to send a certificate, and extension data in the third extension is the identifiers of the client certificates buffered by the server. In specific implementation, the identifiers of the client certificates buffered by the server may be carried in the server handshake message in a form of a list, that is, the extension data in the third extension in the server handshake message may be a list of the identifiers of the client certificates buffered by the server. Certainly, the present invention is not limited to this. The identifiers of the client certificates buffered by the server may also be carried in the server handshake message in a form of a chain or an array, which is not limited by the present invention.

Step 904: The server sends a certificate request message to the client.

Step 905: The client determines whether identifiers of client certificates buffered by the server include an identifier of a certificate that the client is ready to use. If yes, step 906 is performed; and if the identifiers of the client certificates buffered by the server do not include the identifier of the certificate that the client is ready to us, step 911 is performed.

Step 906: The client sends a certificate identifier message to the server, where the certificate identifier message carries the identifier of the certificate that the client is ready to use.

Step 907: The client searches for the server certificate corresponding to the identifier of the certificate that the server is ready to use, among the server certificates buffered by the client.

Step 908: The client encrypts, by using a public key in a server certificate found by searching, a client key exchange message to be sent, and sends an encrypted client key exchange message to the server.

Step 909: The client encrypts, by using a private key of the client, a certificate verification message to be sent, and sends an encrypted certificate verification message to the server.

Step 910: After the server finds, by searching, the client certificate corresponding to the identifier of the certificate that the client is ready to use, among the client certificates buffered by the server, the server decrypts the encrypted certificate verification message by using a public key in the client certificate found by searching, so as to verify an identity of the client. The procedure ends.

Step 911: The client sends a certificate message to the server, where the certificate message sent by the client carries the client certificate that the client is ready to use.

Step 912: The client searches for the server certificate corresponding to the identifier of the certificate that the server is ready to use, among the server certificates buffered by the client.

Step 913: The client encrypts, by using a public key in a server certificate found by searching, a client key exchange message to be sent, and sends an encrypted client key exchange message to the server.

Step 914: The client encrypts, by using a private key of the client, a certificate verification message to be sent, and sends an encrypted certificate verification message to the server.

Step 915: The server decrypts the encrypted certificate verification message by using a public key in the client certificate that is carried in the certificate message sent by the client, so as to verify an identity of the client. The procedure ends.

Step 916: The server sends a server handshake message to the client, where the server handshake message does not carry the identifier of the certificate that the server is ready to use.

Further, when the server needs to perform authentication for the client, the server handshake message may carry an indication of not requiring the client to send a certificate and carry identifiers of client certificates buffered by the server.

Specifically, for the manner in which the server handshake message carries an indication of not requiring the client to send a certificate and carries identifiers of client certificates buffered by the server, reference may be made to the manner provided in step 903, and details are not repeatedly described herein.

Step 917: The server sends a certificate message to the client, where the certificate message sent by the server carries the server certificate that the server is ready to use.

Step 918: The server sends a certificate request message to the client.

Step 919: The client determines whether identifiers of client certificates buffered by the server include an identifier of a certificate that the client is ready to use. If yes, step 920 is performed; and if the identifiers of the client certificates buffered by the server do not include the identifier of the certificate that the client is ready to us, step 924 is performed.

Step 920: The client sends a certificate identifier message to the server, where the certificate identifier message carries the identifier of the certificate that the client is ready to use.

Step 921: The client encrypts, by using a public key in the received server certificate, a client key exchange message to be sent, and sends an encrypted client key exchange message to the server.

Step 922: The client encrypts, by using a private key of the client, a certificate verification message to be sent, and sends an encrypted certificate verification message to the server.

Step 923: After the server finds, by searching, the client certificate corresponding to the identifier of the certificate that the client is ready to use, among the client certificates buffered by the server, the server decrypts the encrypted certificate verification message by using a public key in the client certificate found by searching, so as to verify an identity of the client. The procedure ends.

Step 924: The client sends a certificate message to the server, where the certificate message sent by the client carries the client certificate that the client is ready to use.

Step 925: The client encrypts, by using a public key in the received server certificate, a client key exchange message to be sent, and sends an encrypted client key exchange message to the server.

Step 926: The client encrypts, by using a private key of the client, a certificate verification message to be sent, and sends an encrypted certificate verification message to the server.

Step 927: The server decrypts the encrypted certificate verification message by using a public key in the client certificate that is carried in the certificate message sent by the client, so as to verify an identity of the client. The procedure ends.

In the foregoing embodiment, when identifiers of server certificates which are carried in a client handshake message include an identifier of a certificate that a server is ready to use, the server may not send a certificate message to a client, which may reduce an amount of data in a TLS handshake process and shorten a time occupied by the TLS handshake process, and may further improve a TLS connection speed, and may avoid a problem that a certificate message is sent for multiple times due to an excessively small buffer size, and thereby may further improve the TLS connection speed. In addition, omitting certificate message sending may omit a process of verifying a certificate by the client, and thereby may greatly reduce CPU overheads of the client in the TLS handshake process. In addition, in this embodiment, the server may further perform authentication for the client, which further improves reliability of a TLS connection.

In the embodiment shown in FIG. 9A, FIG. 9B, and FIG. 9C of the present invention, when identifiers of server certificates which are carried in a client handshake message include an identifier of a certificate that a server is ready to use, the server may carry a second extension in a server handshake message, where extension data in the second extension is the identifier of the certificate that the server is ready to use; meanwhile, if the server needs to perform authentication for the client, the server may carry a third extension in the server handshake message, where an extension type of the third extension is not requiring the client to send a certificate, and extension data in the third extension is identifiers of client certificates buffered by the server.

To ensure maximum compatibility, a constraint may be added. That is, the server can include the third extension for the client certificates into the server handshake message only when the client handshake message carries the first extension. In addition, when the server does not support the first extension added to the client handshake message, the server does not include the third extension for the client certificates into the server handshake message.

In addition, if the server cannot identify the first extension added to the client handshake message, the server may directly ignore the first extension added to the client handshake message, and send a certificate message. Likewise, if the client finds, by searching, that the server does not respond, in the server handshake message, to the added first extension, the client may still continue to process the certificate message. Therefore, the method provided by the embodiment shown in FIG. 9A, FIG. 9B, and FIG. 9C of the present invention does not affect interoperability.

In another implementation manner of the embodiment shown in FIG. 9A, FIG. 9B, and FIG. 9C of the present invention, in step 903, when the server needs to perform authentication for the client, the server handshake message may carry only the identifier of the certificate that the server is ready to use and carry the indication of not requiring the client to send a certificate, but does not carry the identifiers of the client certificates buffered by the server. In this way, after step 903, step 904 is performed, and then, step 905 does not need to be performed but steps 906 to step 909 are performed directly. If the server finds, by searching, the client certificate corresponding to the identifier of the certificate that the client is ready to use, among the client certificates buffered by the server, step 910 is performed.

If the server does not find, by searching, the client certificate corresponding to the identifier of the certificate that the client is ready to use, among the client certificates buffered by the server, the server may send an authentication failure response message to the client, where the authentication failure response message carries an authentication failure cause, where the authentication failure cause is that the server does not find, by searching, the client certificate corresponding to the identifier of the certificate that the client is ready to use, among the client certificates buffered by the server; or the server may send a handshake failure message to the client.

After receiving the authentication failure response message or the handshake failure message, the client sends a client handshake message to the server again, where the client handshake message that is sent again carries the indication of not requiring the server to send a certificate and carries the identifiers of the server certificates buffered by the client; then the server sends a server handshake message to the client again, where the server handshake message that is sent again carries the identifier of the certificate that the server is ready to use, but does not carry the indication of not requiring the client to send a certificate. After sending the server handshake message, the server sends a certificate request message. Then, the procedure may be performed according to the procedure described in step 911 to step 915, which is not repeatedly described herein.

Likewise, in step 916, when the server needs to perform authentication for the client, the server handshake message may also carry only the identifier of the certificate that the server is ready to use and carry the indication of not requiring the client to send a certificate, but does not carry the identifiers of the client certificates buffered by the server. The subsequent procedure is similar to the foregoing procedure, and is not further described herein.

The method provided by the embodiment shown in FIG. 9A, FIG. 9B, and FIG. 9C of the present invention may be applied to the scenario shown in FIG. 8, where the network element may be considered as a server, and is generally connected to a network management system (the network management system may be considered as a client) fixedly, and authentication needs to be performed for the network management system to verify an identity of the network management system. By using the method provided by the embodiment shown in FIG. 9A, FIG. 9B, and FIG. 9C of the present invention, the network management system may not send a certificate, which may improve a TLS connection speed, and may reduce handshake overheads of the network management system, and thereby may further improve a processing capability of the network management system.

In a development process, the TLS protocol has many versions, including Secure Sockets Layer version 2 (Secure Sockets Layer version 2, SSLv2 for short), Secure Sockets Layer version 3 (Secure Sockets Layer version 3, SSLv3 for short), TLS 1.0, TLS 1.1, and TLS 1.2, and so on, and a new version may further occur in the future. TLS in the embodiment of the present invention refers to all the versions. For the new version, as long as the TLS protocol of the new version includes certificate authentication, the method provided by the embodiment of the present invention is also applicable to the TLS protocol of the new version.

In addition, the embodiment of the present invention uses only an authentication procedure of a public key encryption algorithm (Rivest Shamir Adleman, RSA for short) of a TLS handshake as an example for description. For other TLS procedures, as long as certificate authentication is included, in an aspect of certificate transfer, the extension introduced in the embodiment of the present invention may be directly used to reduce certificate transfer. Although specific steps of encrypting and signing are different from those described in the embodiment of the present invention, the extension introduced in the embodiment of the present invention is also directly applicable to the procedures.

The following describes, according to a syntax in the TLS protocol, the extensions added to the client handshake message and server handshake message.

1. Add a new type value certificate_not_required (certificate_not_required) to an extension type (ExtensionType), as shown below:

enum {
server_name(0), max_fragment_length(1),
client_certificate_ur1(2), trusted_ca_keys(3),
truncated_hmac(4), status_request(5), certificate_not_required(2049)
} ExtensionType;

The type value certificate_not_required (certificate_not_required) can be used in only a proprietary protocol. The specific type value can be incorporated into a standard protocol only after the specific type value is approved by the Internet Engineering Task Force Internet Assigned Numbers Authority (Internet Engineering Task Force Internet Assigned Numbers Authority, IETF IANA for short). However, the certificate_not_required type value does not affect interoperability.

2. Define a certificate identifier type list (CertificateIDTypeList), as shown below:

enum {
snname(1), md5(2),
(255)
} CertificateIDType;
struct{
CertificateSerialNumber serialNumber;
Name issuer;
}CertificateSnName;
struct {
CertificateIDType id_type;
select (id_type) {
case snname:
CertificateSnName SnName_list<0..2\hat{ }16-1>;
case md5:
MD5Hash MD5_list<0..2\hat{ }16-1>;
} CertificateIDList;
} CertificateIDTypeList
opaque MD5Hash[16];

Name and CertificateSerialNumber come from an x.509 standard, and values of Name and CertificateSerialNumber correspond to corresponding distinguished encoding rules (Distinguished Encoding Rules, DER for short) code.

For
struct {
ExtensionType extension_type;
opaque extension_data<0..2\hat{ }16-1>;
} Extension;

when the value of extension type is certificate_not_required (certificate_not_required), the value of the extension_data is CertificateIDTypeList.

In the present invention, the foregoing extension may be added to both the client handshake message and server handshake message.

In the present invention, any certificate may be uniquely identified by an issuer (issuer) and a certificate serial number (serialNumber) in the certificate, or may be identified by a hash value after the issuer (issuer) and the certificate serial number (serialNumber) are connected, for example, a message digest algorithm 5 (Message Digest Algorithm 5, MD5 for short). The foregoing hash value is used to identify the certificate, which may reduce the size of the client handshake message.

In the embodiment shown in FIG. 9A, FIG. 9B, and FIG. 9C of the present invention, a new handshake message type needs to be added, as shown below:

enum {
hello_request(0), client_hello(1), server_hello(2),
certificate(11), server_key_exchange (12),
certificate_request(13), server_hello_done(14),
certificate_verify(15), client_key_exchange(16),
finished(20), certificate_url(21), certificate_status(22), certificate_id (201),
(255)
} HandshakeType;

The certificate_id type value can be used in only the proprietary protocol. The certificate_id type value can be incorporated into a standard protocol only after the certificate_id type value is approved by the IETF IANA. However, the certificate_id type value does not affect interoperability.

For a certificate_id message, a format of the certificate_id message is the same as the format of the CertificateIDTypeList, and fixedly includes 1 element, namely, an identifier of a certificate that the client is ready to use.

Persons of ordinary skill in the art may understand that all or a part of the steps of the method embodiments may be implemented by a program instructing relevant hardware. The program may be stored in a computer readable storage medium. When the program runs, the steps of the method embodiments are performed. The foregoing storage medium includes any medium that can store program code, such as a ROM, a RAM, a magnetic disk, or an optical disc.

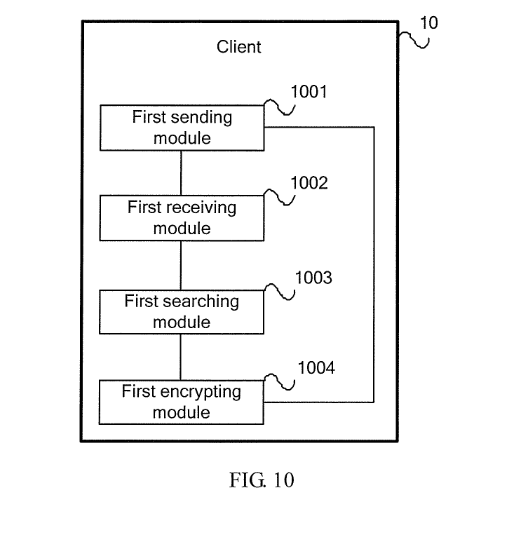

FIG. 10 is a schematic structural diagram of an embodiment of a client according to the present invention. A client 10 in this embodiment may implement a procedure of the embodiment shown in FIG. 1 of the present invention. As shown in FIG. 10, the client 10 may include: a first sending module 1001, a first receiving module 1002, a first searching module 1003, and a first encrypting module 1004.

The first sending module 1001 is configured to send a client handshake message to a server, where the client handshake message carries identifiers of server certificates buffered by the client; and receive an encrypted client key exchange message from the first encrypting module 1004, and send the encrypted client key exchange message to the server; further, the client handshake message may further carry an indication of not requiring the server to send a certificate.

The first receiving module 1002 is configured to receive a server handshake message sent by the server, where when the server determines that the identifiers of the server certificates buffered by the client include an identifier of a certificate that the server is ready to use, the server handshake message carries the identifier of the certificate that the server is ready to use; and transfer the identifier of the certificate that the server is ready to use to the first searching module 1003.

The first searching module 1003 is configured to receive, from the first receiving module 1002, the identifier of the certificate that the server is ready to use, and search for the server certificate corresponding to the identifier of the certificate that the server is ready to use, among the server certificates buffered by the client; and transfer a server certificate found by searching to the first encrypting module 1004.

The first encrypting module 1004 is configured to receive, from the first searching module 1003, the server certificate found by searching, encrypt, by using a public key in the server certificate found by searching, the client key exchange message to be sent, and transfer the encrypted client key exchange message to the first sending module 1001.

In the foregoing embodiment, a first sending module 1001 sends a client handshake message, which carries identifiers of server certificates buffered by the client, to a server; when the server determines that the identifiers of the server certificates buffered by the client include an identifier of a certificate that the server is ready to use, the server may not send a certificate message, but sends a server handshake message, which carries the identifier of the certificate that the server is ready to use, to the client; and then a first searching module 1003 searches for the server certificate corresponding to the identifier of the certificate that the server is ready to use, among the server certificates buffered by the client; and a first encrypting module 1004 encrypts, by using a public key in a server certificate found by searching, a client key exchange message to be sent, and then the first sending module 1001 sends an encrypted client key exchange message to the server. In this embodiment, the server may not send a certificate message to the client, which may reduce an amount of data in a TLS handshake process and shorten a time occupied by the TLS handshake process, and may further improve a TLS connection speed, and may avoid a problem that a certificate message is sent for multiple times due to an excessively small buffer size, and thereby may further improve the TLS connection speed.

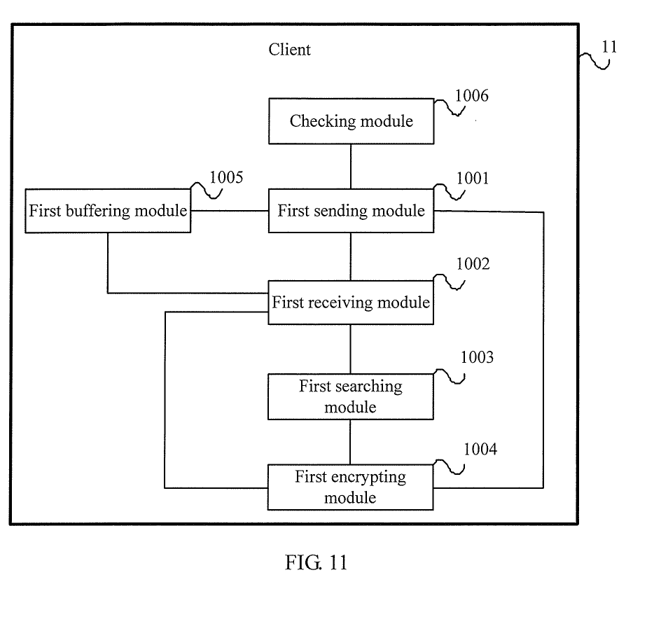

FIG. 11 is a schematic structural diagram of another embodiment of a client according to the present invention. Different from the client shown in FIG. 10, a client 11 in this embodiment may further include: a first buffering module 1005.

The first buffering module 1005 is configured to buffer, in a process of interaction with the server, the server certificates sent by the server; and transfer the buffered server certificates to the first sending module 1001.

In an implementation manner of this embodiment, when the server determines that the identifiers of the server certificates buffered by the client do not include the identifier of the certificate that the server is ready to use, the server handshake message received by the first receiving module 1002 does not carry the identifier of the certificate that the server is ready to use; in this case, the first receiving module 1002 is further configured to receive, after receiving the server handshake message that does not carry the identifier of the certificate that the server is ready to use, a certificate message sent by the server, where the certificate message sent by the server carries the server certificate that the server is ready to use; and transfer the server certificate that the server is ready to use to the first buffering module 1005 and the first encrypting module 1004 separately;
in this case, the first buffering module 1005 is further configured to receive, from the first receiving module 1002, the server certificate that the server is ready to use, and buffer the server certificate that the server is ready to use; and
the first encrypting module 1004 is further configured to receive, from the first receiving module 1002, the server certificate that the server is ready to use, and encrypt, by using the public key in the server certificate that the server is ready to use, the client key exchange message to be sent.

Further, the client 11 may further include a checking module 1006.

The checking module 1006 is configured to check, before the first sending module 1001 sends the client handshake message, validity of the server certificates buffered by the client; and transfer identifiers of valid server certificates buffered by the client to the first sending module 1001.

The first sending module 1001 is further configured to receive, from the checking module 1006, the identifiers of the valid server certificates buffered by the client, where the identifiers of the server certificates buffered by the client, which are carried in the client handshake message sent by the first sending module 1001, include the identifiers of the valid server certificates buffered by the client.

In another implementation manner of this embodiment, the server handshake message received by the first receiving module 1002 further carries an indication of not requiring the client to send a certificate and carries identifiers of client certificates buffered by the server;
the first receiving module 1002 is further configured to receive, after receiving the server handshake message sent by the server, a certificate request message sent by the server;
the first sending module 1001 is further configured to send, when the client determines that the identifiers of the client certificates buffered by the server include an identifier of a certificate that the client is ready to use, a certificate identifier message to the server according to the certificate request message sent by the server, where the certificate identifier message carries the identifier of the certificate that the client is ready to use; and receive an encrypted certificate verification message from the first encrypting module 1004, and send the encrypted certificate verification message to the server, so that after the server finds, by searching, the client certificate corresponding to the identifier of the certificate that the client is ready to use, among the client certificates buffered by the server, the server decrypts the encrypted certificate verification message by using a public key in the client certificate found by searching, so as to verify an identity of the client; and
the first encrypting module 1004 is further configured to encrypt, by using a private key that matches the certificate that the client is ready to use, the certificate verification message to be sent, and transfer the encrypted certificate verification message to the first sending module 1001.

Further, the first sending module 1001 is further configured to send, when the client determines that the identifiers of the client certificates buffered by the server do not include the identifier of the certificate that the client is ready to use, a certificate message to the server according to the certificate request message sent by the server, where the certificate message sent by the first sending module 1001 carries the client certificate that the client is ready to use.

In still another implementation manner of this embodiment, the server handshake message received by the first receiving module 1002 further carries an indication of not requiring the client to send a certificate;
the first receiving module 1002 is further configured to receive, after receiving the server handshake message sent by the server, a certificate request message sent by the server;
the first sending module 1001 is further configured to send a certificate identifier message to the server, where the certificate identifier message carries an identifier of a certificate that the client is ready to use; and receive an encrypted certificate verification message from the first encrypting module 1004, and send the encrypted certificate verification message to the server, so that after the server finds, by searching, the client certificate corresponding to the identifier of the certificate that the client is ready to use, among client certificates buffered by the server, the server decrypts the encrypted certificate verification message by using a public key in the client certificate found by searching, so as to verify an identity of the client; and
the first encrypting module 1004 is further configured to encrypt, by using a private key that matches the certificate that the client is ready to use, the certificate verification message to be sent, and transfer the encrypted certificate verification message to the first sending module 1001.

In the foregoing embodiment, the server may not send a certificate message to the client, which may reduce an amount of data in a TLS handshake process and shorten a time occupied by the TLS handshake process, and may further improve a TLS connection speed, and may avoid a problem that a certificate message is sent for multiple times due to an excessively small buffer size, and thereby may further improve the TLS connection speed.

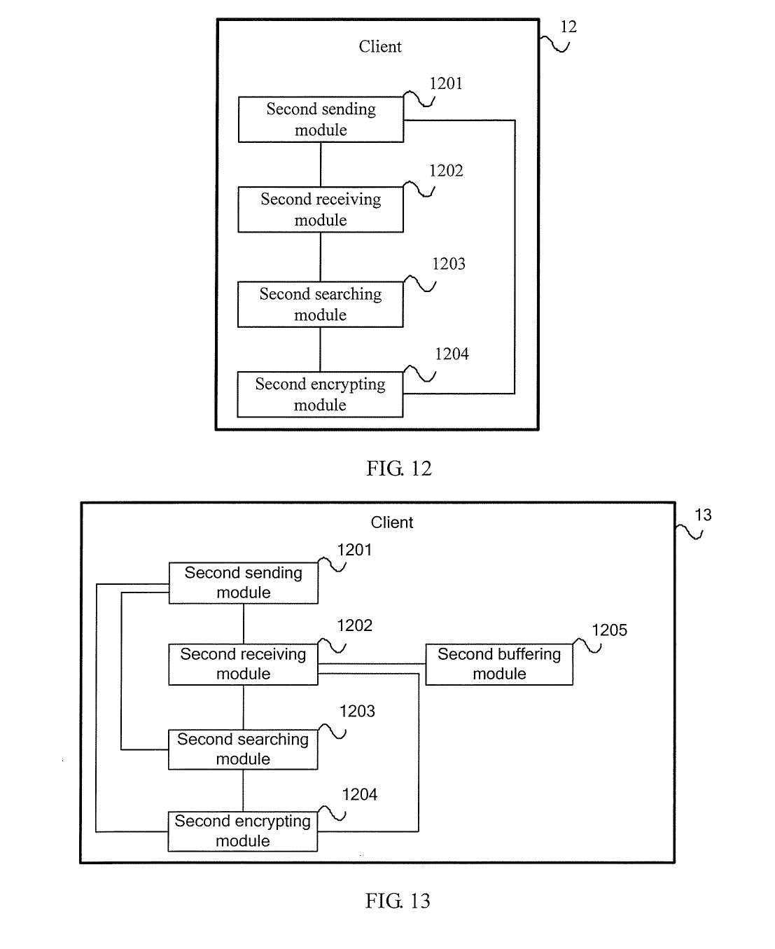

FIG. 12 is a schematic structural diagram of still another embodiment of a client according to the present invention. The client in this embodiment may implement a procedure of the embodiment shown in FIG. 2 of the present invention. As shown in FIG. 12, the client 12 may include: a second sending module 1201, a second receiving module 1202, a second searching module 1203, and a second encrypting module 1204.

The second sending module 1201 is configured to send a first client handshake message to a server, where the first client handshake message carries an indication of not requiring the server to send a certificate; and receive an encrypted client key exchange message from the second encrypting module 1204, and send the encrypted client key exchange message to the server.

The second receiving module 1202 is configured to receive a server handshake message sent by the server, where the server handshake message carries an identifier of a certificate that the server is ready to use; and transfer the identifier of the certificate that the server is ready to use to the second searching module 1203.

The second searching module 1203 is configured to receive, from the second receiving module 1202, the identifier of the certificate that the server is ready to use, and search for the server certificate corresponding to the identifier of the certificate that the server is ready to use, among server certificates buffered by the client; and when finding, by searching, by searching, the server certificate corresponding to the identifier of the certificate that the server is ready to use, transfer the server certificate found by searching to the second encrypting module 1204.

The second encrypting module 1204 is configured to receive, from the second searching module 1203, the server certificate found by searching, encrypt, by using a public key in the server certificate found by searching, the client key exchange message to be sent, and transfer the encrypted client key exchange message to the second sending module 1201.

In the foregoing embodiment, a second sending module 1201 sends a first client handshake message, which carries an indication of not requiring a server to send a certificate, to the server; after receiving the first client handshake message, the server does not send a certificate message, but sends a server handshake message, which carries an identifier of a certificate that the server is ready to use, to the client; and if a second searching module 1203 finds, by searching, the server certificate corresponding to the identifier of the certificate that the server is ready to use, among server certificates buffered by the client, a second encrypting module 1204 may encrypt, by using a public key in the server certificate found by searching, a client key exchange message to be sent, and the second sending module 1201 sends an encrypted client key exchange message to the server. In the foregoing embodiment, the server may not send a certificate message to the client, which may reduce an amount of data in a TLS handshake process and shorten a time occupied by the TLS handshake process, and may further improve a TLS connection speed, and may avoid a problem that a certificate message is sent for multiple times due to an excessively small buffer size, and thereby may further improve the TLS connection speed.

FIG. 13 is a schematic structural diagram of still another embodiment of a client according to the present invention. Different from the client shown in FIG. 12, a client 13 shown in FIG. 13 may further include: a second buffering module 1205.

The second sending module 1201 is further configured to send a second client handshake message to the server again when the second searching module 1203 does not find, by searching, the server certificate corresponding to the identifier of the certificate that the server is ready to use, among the server certificates buffered by the client, where the second client handshake message does not carry the indication of not requiring the server to send a certificate.

The second receiving module 1202 is further configured to receive a certificate message sent by the server, where the certificate message sent by the server carries the server certificate that the server is ready to use; and transfer the server certificate that the server is ready to use to the second buffering module 1205 and the second encrypting module 1204 separately.

The second buffering module 1205 is further configured to receive, from the second receiving module 1202, the server certificate that the server is ready to use, and buffer the server certificate that the server is ready to use.

The second encrypting module 1204 is further configured to receive, from the second receiving module 1202, the server certificate that the server is ready to use, and encrypt, by using the public key in the server certificate, the client key exchange message to be sent.

In the foregoing embodiment, the server may not send a certificate message to the client, which may reduce an amount of data in a TLS handshake process and shorten a time occupied by the TLS handshake process, and may further improve a TLS connection speed, and may avoid a problem that a certificate message is sent for multiple times due to an excessively small buffer size, and thereby may further improve the TLS connection speed.

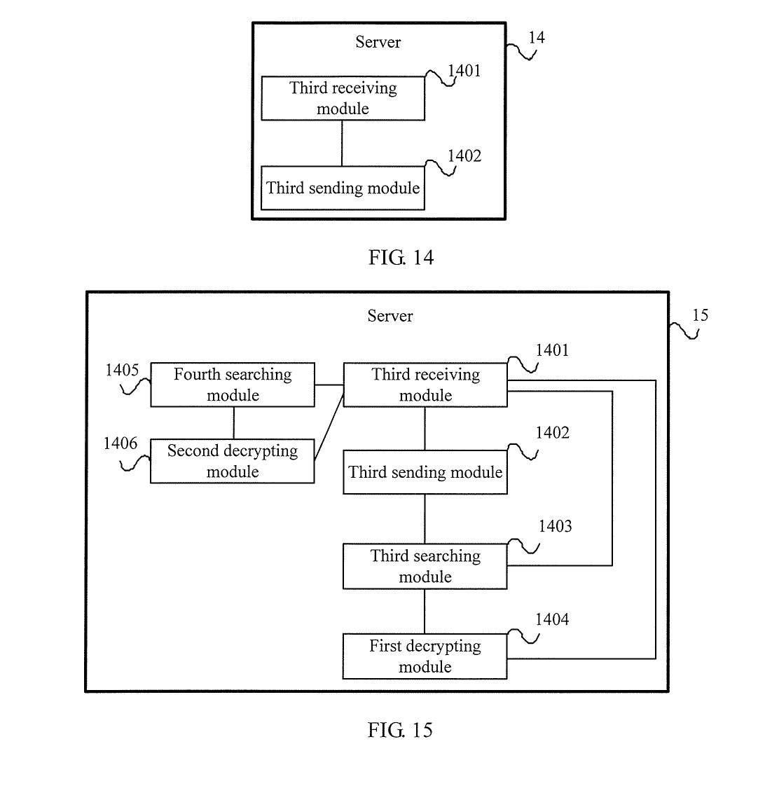

FIG. 14 is a schematic structural diagram of an embodiment of a server according to the present invention. The server in this embodiment may implement a procedure of the embodiment shown in FIG. 3 of the present invention. As shown in FIG. 14, the server 14 may include: a third receiving module 1401 and a third sending module 1402.

The third receiving module 1401 is configured to receive a client handshake message sent by a client, where the client handshake message carries identifiers of server certificates buffered by the client; and transfer the identifiers of the server certificates buffered by the client to the third sending module 1402; and receive an encrypted client key exchange message sent by the client, where the encrypted client key exchange message is sent to the server after the client finds, by searching, a server certificate corresponding to an identifier of the certificate that the server is ready to use, among the server certificates buffered by the client, and encrypts, by using a public key in the server certificate found by searching, the client key exchange message to be sent.

Further, the client handshake message may further carry an indication of not requiring the server to send a certificate. Therefore, the third receiving module 1401 further needs to transfer the indication of not requiring the server to send a certificate, to the third sending module 1402.

The third sending module 1402 is configured to receive, from the third receiving module 1401, the identifiers of the server certificates buffered by the client, and send a server handshake message to the client, where when it is determined that the identifiers of the server certificates buffered by the client include the identifier of the certificate that the server is ready to use, the server handshake message sent by the third sending module 1402 carries the identifier of the certificate that the server is ready to use.

Further, the third sending module 1402 is further configured to send, in a process of interaction with the client, the server certificates to the client, so that the client buffers the server certificates sent by the server.

In an implementation manner of this embodiment, when it is determined that the identifiers of the server certificates buffered by the client do not include the identifier of the certificate that the server is ready to use, the server handshake message sent by the third sending module 1402 does not carry the identifier of the certificate that the server is ready to use;
the third sending module 1402 is further configured to send a certificate message to the client after sending the server handshake message to the client, where the certificate message sent by the third sending module 1402 carries the server certificate that the server is ready to use, so that the client buffers the server certificate that the server is ready to use; and
the third receiving module 1401 is further configured to receive the encrypted client key exchange message sent by the client, where the encrypted client key exchange message is sent to the server after the client receives the server certificate that the server is ready to use, and encrypts, by using the public key in the server certificate that the server is ready to use, the client key exchange message to be sent.

In this embodiment, the identifiers of the server certificates buffered by the client, which are carried in the client handshake message received by the third receiving module 1401, include identifiers of valid server certificates buffered by the client. That is, before sending the client handshake message, the client checks validity of the server certificates buffered by the client, and sends the client handshake message, which carries the identifiers of the valid server certificates buffered by the client, to the server.

In the foregoing embodiment, after a third receiving module 1401 receives a client handshake message sent by a client and carrying identifiers of server certificates buffered by the client, when the server determines that the identifiers of the server certificates buffered by the client include an identifier of a certificate that the server is ready to use, the server may not send a certificate message, but sends a server handshake message, which carries the identifier of the certificate that the server is ready to use, to the client. In this embodiment, the server may not send a certificate message to the client, which may reduce an amount of data in a TLS handshake process and shorten a time occupied by the TLS handshake process, and may further improve a TLS connection speed, and may avoid a problem that a certificate message is sent for multiple times due to an excessively small buffer size, and thereby may further improve the TLS connection speed.

FIG. 15 is a schematic structural diagram of another embodiment of a server according to the present invention. Different from the server shown in FIG. 14, a server 15 shown in FIG. 15 may further include: a third searching module 1403 and a first decrypting module 1404.

In this embodiment, the server handshake message sent by the third sending module 1402 further carries an indication of not requiring the client to send a certificate and carries identifiers of client certificates buffered by the server.

The third sending module 1402 is further configured to send a certificate request message to the client after sending the server handshake message to the client.

In an implementation manner of this embodiment, the third receiving module 1401 is further configured to receive a certificate identifier message that is sent by the client after the client determines that the identifiers of the client certificates buffered by the server include an identifier of a certificate that the client is ready to use, where the certificate identifier message carries the identifier of the certificate that the client is ready to use; and transfer the identifier of the certificate that the client is ready to use to the third searching module 1403; and receive an encrypted certificate verification message sent by the client, and transfer the encrypted certificate verification message to the first decrypting module 1404, where the encrypted certificate verification message is sent to the server after the client encrypts, by using a private key that matches the certificate that the client is ready to use, the certificate verification message to be sent;
the third searching module 1403 is configured to receive, from the third receiving module 1401, the identifier of the certificate that the client is ready to use, and search for the client certificate corresponding to the identifier of the certificate that the client is ready to use, among the client certificates buffered by the server; and transfer a client certificate found by searching to the first decrypting module 1404; and
the first decrypting module 1404 is configured to receive the encrypted certificate verification message from the third receiving module 1401, and receive the client certificate from the third searching module 1403, and decrypt the encrypted certificate verification message by using a public key in the client certificate, so as to verify an identity of the client.

In another implementation manner of this embodiment, the third receiving module 1401 is further configured to receive a certificate message that is sent by the client after the client determines that the identifiers of the client certificates buffered by the server do not include an identifier of a certificate that the client is ready to use, where the certificate message sent by the client carries the client certificate that the client is ready to use; and receive an encrypted certificate verification message sent by the client, where the encrypted certificate verification message is sent to the server after the client encrypts, by using a private key that matches the certificate that the client is ready to use, the certificate verification message to be sent; and transfer the client certificate and the encrypted certificate verification message to the first decrypting module 1404; and
the first decrypting module 1404 is further configured to receive the client certificate and the encrypted certificate verification message from the third receiving module 1401, and decrypt the encrypted certificate verification message by using a public key in the client certificate, so as to verify an identity of the client.

In still another implementation manner of this embodiment, the server 15 may further include a fourth searching module 1405 and a second decrypting module 1406.

In this implementation manner, the server handshake message sent by the third sending module 1402 may further carry an indication of not requiring the client to send a certificate, but does not carry the identifiers of the client certificates buffered by the server;
the third sending module 1402 is further configured to send a certificate request message to the client after sending the server handshake message to the client;
the third receiving module 1401 is further configured to receive a certificate identifier message sent by the client, where the certificate identifier message carries an identifier of a certificate that the client is ready to use; and transfer the identifier of the certificate that the client is ready to use to the fourth searching module 1405; and receive an encrypted certificate verification message sent by the client, and transfer the encrypted certificate verification message to the second decrypting module 1406, where the encrypted certificate verification message is sent to the server after the client encrypts, by using a private key that matches the certificate that the client is ready to use, the certificate verification message to be sent;
the fourth searching module 1405 is configured to receive, from the third receiving module 1401, the identifier of the certificate that the client is ready to use, and search for the client certificate corresponding to the identifier of the certificate that the client is ready to use, among the client certificates buffered by the server; and transfer a client certificate found by searching to the second decrypting module 1406; and
the second decrypting module 1406 is configured to receive the encrypted certificate verification message from the third receiving module 1401, and receive the client certificate from the fourth searching module 1405, and decrypt the encrypted certificate verification message by using a public key in the client certificate, so as to verify an identity of the client.

In the foregoing embodiment, the server may not send a certificate message to the client, which may reduce an amount of data in a TLS handshake process and shorten a time occupied by the TLS handshake process, and may further improve a TLS connection speed, and may avoid a problem that a certificate message is sent for multiple times due to an excessively small buffer size, and thereby may further improve the TLS connection speed.

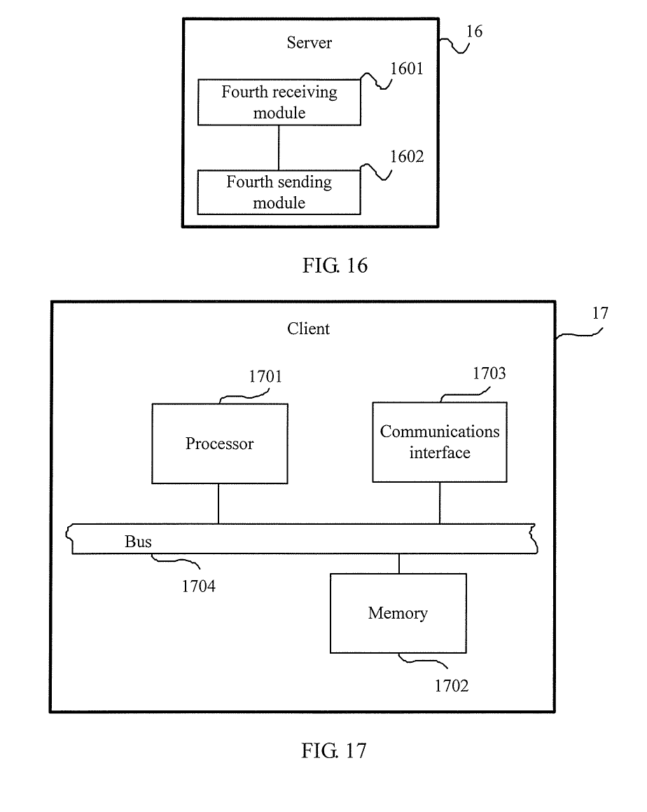

FIG. 16 is a schematic structural diagram of still another embodiment of a server according to the present invention. A server 16 in this embodiment may implement a procedure of the embodiment shown in FIG. 4 of the present invention. As shown in FIG. 16, the server 16 may include: a fourth receiving module 1601 and a fourth sending module 1602.

The fourth receiving module 1601 is configured to receive a first client handshake message sent by a client, where the first client handshake message carries an indication of not requiring the server to send a certificate; and send the indication of not requiring the server to send a certificate, to the fourth sending module 1602.

The fourth sending module 1602 is configured to receive, from the fourth receiving module, the indication of not requiring the server to send a certificate, and send a server handshake message to the client, where the server handshake message carries an identifier of a certificate that the server is ready to use.

The fourth receiving module 1601 is further configured to receive an encrypted client key exchange message sent by the client after the client finds, by searching, the server certificate corresponding to the identifier of the certificate that the server is ready to use, among server certificates buffered by the client, where the encrypted client key exchange message is sent to the server after the client encrypts, by using a public key in the server certificate found by searching, the client key exchange message to be sent.

In an implementation manner of this embodiment, the fourth receiving module 1601 is further configured to receive a second client handshake message that is sent again by the client after the client does not find, by searching, the server certificate corresponding to the identifier of the certificate that the server is ready to use, among the server certificates buffered by the client, where the second client handshake message does not carry the indication of not requiring the server to send a certificate; and receive the encrypted client key exchange message sent by the client, where the encrypted client key exchange message is sent to the server after the client receives the server certificate that the server is ready to use, and encrypts, by using the public key in the server certificate, the client key exchange message to be sent; and
the fourth sending module 1602 is further configured to send a certificate message to the client, where the certificate message sent by the fourth sending module 1602 carries the server certificate that the server is ready to use, so that the client buffers the server certificate that the server is ready to use.

In the foregoing embodiment, after a fourth receiving module 1601 receives a first client handshake message sent by a client and carrying an indication of not requiring the server to send a certificate, a fourth sending module 1602 does not send a certificate message to the client, but sends a server handshake message, which carries an identifier of a certificate that the server is ready to use, to the client. In this embodiment, the server may not send a certificate message to the client, which may reduce an amount of data in a TLS handshake process and shorten a time occupied by the TLS handshake process, and may further improve a TLS connection speed, and may avoid a problem that a certificate message is sent for multiple times due to an excessively small buffer size, and thereby may further improve the TLS connection speed.

FIG. 17 is a schematic structural diagram of still another embodiment of a client according to the present invention. As shown in FIG. 17, the client 17 may include: a bus 1704, at least one processor 1701, a communications interface 1703, and a memory 1702, where the processor 1701, memory 1702, and communications interface 1703 are all connected to the bus 1704. The memory 1702 is configured to store executable program code. The processor 1701 runs, by reading the executable program code stored in the memory 1702, a program corresponding to the executable program code, so that the client implements the following functions: sending a client handshake message to a server, where the client handshake message carries identifiers of server certificates buffered by the client; receiving a server handshake message sent by the server, where when the server determines that the identifiers of the server certificates buffered by the client include an identifier of a certificate that the server is ready to use, the server handshake message carries the identifier of the certificate that the server is ready to use; searching for the server certificate corresponding to the identifier of the certificate that the server is ready to use, among the server certificates buffered by the client; and encrypting, by using a public key in a server certificate found by searching, a client key exchange message to be sent, and sending an encrypted client key exchange message to the server.

In this embodiment, the communications interface 1703 may be specifically a network interface adaptor (or called a network card), or may be a device such as an antenna that may be used as a transmitter and a receiver separately or respectively, and is mainly configured to establish a communication channel with the server, and implement message sending and receiving under an instruction of the processor 1701.

In the foregoing embodiment, the server may not send a certificate message to the client, which may reduce an amount of data in a TLS handshake process and shorten a time occupied by the TLS handshake process, and may further improve a TLS connection speed, and may avoid a problem that a certificate message is sent for multiple times due to an excessively small buffer size, and thereby may further improve the TLS connection speed.

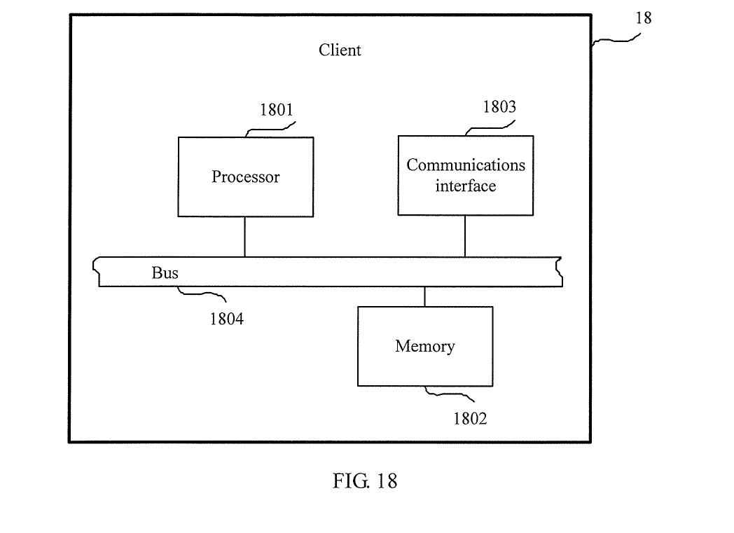

FIG. 18 is a schematic structural diagram of still another embodiment of a client according to the present invention. As shown in FIG. 18, the client 18 may include: a bus 1804, at least one processor 1801, a communications interface 1803, and a memory 1802, where the processor 1801, memory 1802, and communications interface 1803 are all connected to the bus 1804. The memory 1802 is configured to store executable program code. The processor 1801 runs, by reading the executable program code stored in the memory 1802, a program corresponding to the executable program code, so that the client implements the following functions: sending a first client handshake message to a server, where the first client handshake message carries an indication of not requiring the server to send a certificate; receiving a server handshake message sent by the server, where the server handshake message carries an identifier of a certificate that the server is ready to use; if the client finds, by searching, the server certificate corresponding to the identifier of the certificate that the server is ready to use, among server certificates buffered by the client, encrypting, by using a public key in the server certificate found by searching, a client key exchange message to be sent, and sending an encrypted client key exchange message to the server.

In this embodiment, the communications interface 1803 may be specifically a network card, or may be a device such as an antenna that may be used as a transmitter and a receiver separately or respectively, and is mainly configured to establish a communication channel with the server, and implement message sending and receiving under an instruction of the processor 1801.

In the foregoing embodiment, the server may not send a certificate message to the client, which may reduce an amount of data in a TLS handshake process and shorten a time occupied by the TLS handshake process, and may further improve a TLS connection speed, and may avoid a problem that a certificate message is sent for multiple times due to an excessively small buffer size, and thereby may further improve the TLS connection speed.

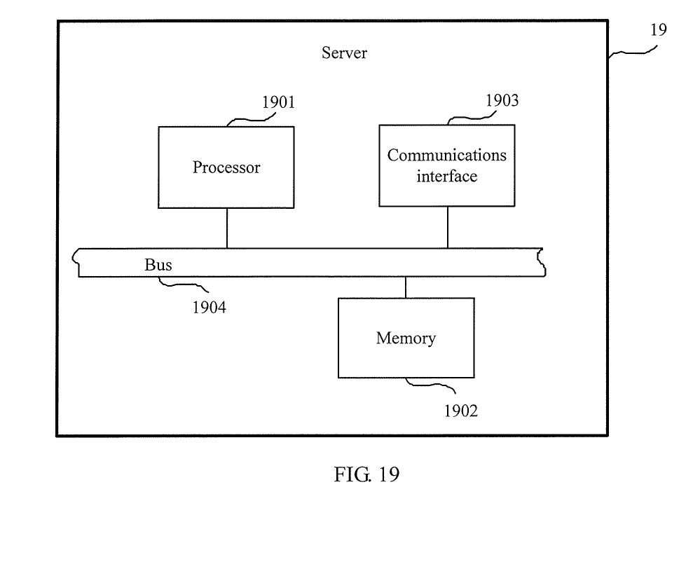

FIG. 19 is a schematic structural diagram of still another embodiment of a server according to the present invention. As shown in FIG. 19, the server 19 may include: a bus 1904, at least one processor 1901, a communications interface 1903, and a memory 1902, where the processor 1901, memory 1902, and communications interface 1903 are all connected to the bus 1904. The memory 1902 is configured to store executable program code. The processor 1901 runs, by reading the executable program code stored in the memory 1902, a program corresponding to the executable program code, so that the server implements the following functions: receiving a client handshake message sent by a client, where the client handshake message carries identifiers of server certificates buffered by the client; sending a server handshake message to the client, where when the server determines that the identifiers of the server certificates buffered by the client include an identifier of a certificate that the server is ready to use, the server handshake message carries the identifier of the certificate that the server is ready to use; and receiving an encrypted client key exchange message sent by the client, where the encrypted client key exchange message is sent to the server after the client finds, by searching, the server certificate corresponding to the identifier of the certificate that the server is ready to use, among the server certificates buffered by the client, and encrypts, by using a public key in the server certificate found by searching, the client key exchange message to be sent.

In this embodiment, the communications interface 1903 may be specifically a network card, and is configured to establish a communication channel with the client, and implement message sending and receiving with the client under an instruction of the processor 1901.

In the foregoing embodiment, the server may not send a certificate message to the client, which may reduce an amount of data in a TLS handshake process and shorten a time occupied by the TLS handshake process, and may further improve a TLS connection speed, and may avoid a problem that a certificate message is sent for multiple times due to an excessively small buffer size, and thereby may further improve the TLS connection speed.

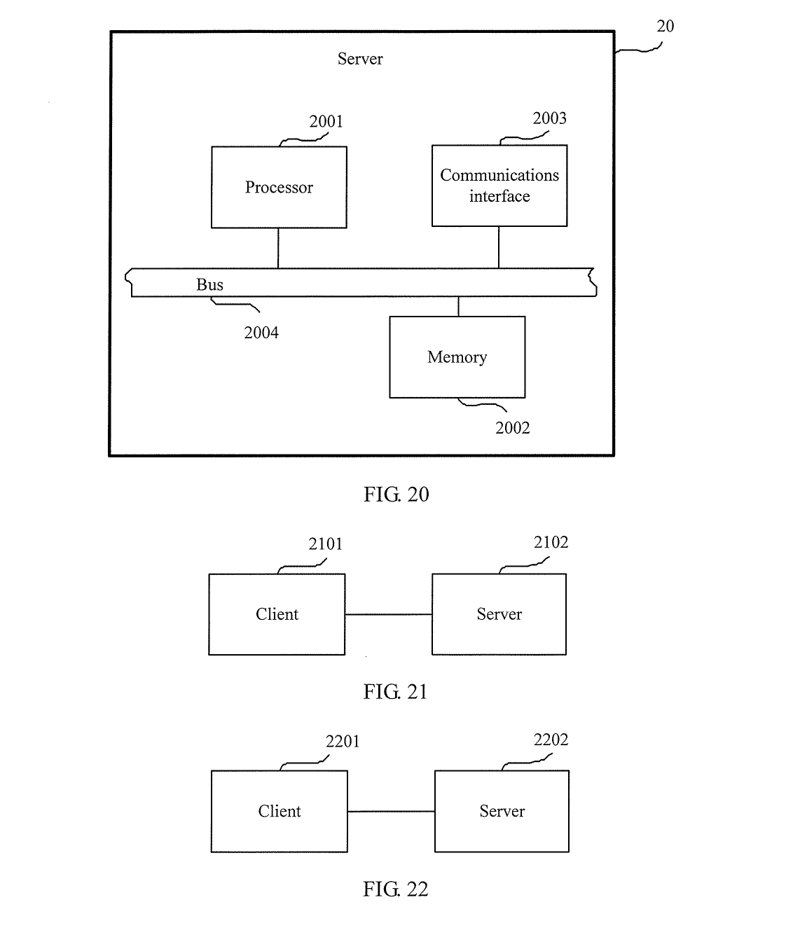

FIG. 20 is a schematic structural diagram of still another embodiment of a server according to the present invention. As shown in FIG. 20, the server 20 may include: a bus 2004, at least one processor 2001, a communications interface 2003, and a memory 2002, where the processor 2001, memory 2002, and communications interface 2003 are all connected to the bus 2004. The memory 2002 is configured to store executable program code. The processor 2001 runs, by reading the executable program code stored in the memory 2002, a program corresponding to the executable program code, so that the server implements the following functions: receiving a first client handshake message sent by a client, where the first client handshake message carries an indication of not requiring the server to send a certificate; sending a server handshake message to the client, where the server handshake message carries an identifier of a certificate that the server is ready to use; receiving an encrypted client key exchange message sent by the client after the client finds, by searching, the server certificate corresponding to the identifier of the certificate that the server is ready to use, among server certificates buffered by the client, where the encrypted client key exchange message is sent to the server after the client encrypts, by using a public key in the server certificate found by searching, the client key exchange message to be sent.

In this embodiment, the communications interface 2003 may be specifically a network card, and is configured to establish a communication channel with the client, and implement message sending and receiving with the client under an instruction of the processor 2001.

In the foregoing embodiment, the server may not send a certificate message to the client, which may reduce an amount of data in a TLS handshake process and shorten a time occupied by the TLS handshake process, and may further improve a TLS connection speed, and may avoid a problem that a certificate message is sent for multiple times due to an excessively small buffer size, and thereby may further improve the TLS connection speed.

FIG. 21 is a schematic structural diagram of an embodiment of a message exchange system according to the present invention. As shown in FIG. 21, the message exchange system may include at least one client 2101 and at least one server 2102.

The client 2101 is configured to: send a client handshake message to the server 2102, where the client handshake message carries identifiers of server certificates buffered by the client; receive a server handshake message sent by the server 2102, where when the server 2102 determines that the identifiers of the server certificates buffered by the client 2101 include an identifier of a certificate that the server 2102 is ready to use, the server handshake message carries the identifier of the certificate that the server 2102 is ready to use; search for the server certificate corresponding to the identifier of the certificate that the server 2102 is ready to use, among the server certificates buffered by the client 2101; and encrypt, by using a public key in a server certificate found by searching, a client key exchange message to be sent, and send an encrypted client key exchange message to the server 2102.

The server 2102 is configured to: receive the client handshake message sent by the client 2101, where the client handshake message carries the identifiers of the server certificates buffered by the client 2101; send the server handshake message to the client 2101, where when the server 2102 determines that the identifiers of the server certificates buffered by the client 2101 include the identifier of the certificate that the server 2102 is ready to use, the server handshake message carries the identifier of the certificate that the server 2102 is ready to use; and receive the encrypted client key exchange message sent by the client 2101, where the encrypted client key exchange message is sent to the server 2102 after the client 2101 finds, by searching, the server certificate corresponding to the identifier of the certificate that the server 2102 is ready to use, among the server certificates buffered by the client 2101, and encrypts, by using the public key in the server certificate found by searching, the client key exchange message to be sent.

FIG. 21 illustrates an example in which a message exchange system includes one client 2101 and one server 2102.

In the foregoing message exchange system, a server 2102 may not send a certificate message to a client 2101, which may reduce an amount of data in a TLS handshake process and shorten a time occupied by the TLS handshake process, and may further improve a TLS connection speed, and may avoid a problem that a certificate message is sent for multiple times due to an excessively small buffer size, and thereby may further improve the TLS connection speed.

FIG. 22 is a schematic structural diagram of another embodiment of a message exchange system according to the present invention. As shown in FIG. 22, the message exchange system may include at least one client 2201 and at least one server 2202.

The client 2201 is configured to: send a first client handshake message to the server 2202, where the first client handshake message carries an indication of not requiring the server to send a certificate; receive a server handshake message sent by the server 2202, where the server handshake message carries an identifier of a certificate that the server 2202 is ready to use; and if the client 2201 finds, by searching, the server certificate corresponding to the identifier of the certificate that the server is ready to use, among server certificates buffered by the client 2201, encrypt, by using a public key in the server certificate found by searching, a client key exchange message to be sent, and send an encrypted client key exchange message to the server 2202.

The server 2202 is configured to: receive the first client handshake message sent by the client 2201, where the first client handshake message carries the indication of not requiring the server to send a certificate; send the server handshake message to the client 2201, where the server handshake message carries the identifier of the certificate that the server 2202 is ready to use; and receive the encrypted client key exchange message sent by the client 2201 after the client 2201 finds, by searching, the server certificate corresponding to the identifier of the certificate that the server 2202 is ready to use, among the server certificates buffered by the client 2201, where the encrypted client key exchange message is sent to the server 2202 after the client 2201 encrypts, by using the public key in the server certificate found by searching, the client key exchange message to be sent.

FIG. 22 illustrates an example in which a message exchange system includes one client 2201 and one server 2202.

In the foregoing message exchange system, a server 2202 may not send a certificate message to a client 2201, which may reduce an amount of data in a TLS handshake process and shorten a time occupied by the TLS handshake process, and may further improve a TLS connection speed, and may avoid a problem that a certificate message is sent for multiple times due to an excessively small buffer size, and thereby may further improve the TLS connection speed.

In conclusion, the message sending and receiving method, client, server, and system provided by the embodiments of the present invention have the following technical effects: By omitting certificate message transfer in a TLS handshake process, TLS handshake performance may be optimized. In a low-speed network, omitting certificate message transfer may greatly reduce an amount of data in the TLS handshake process and thereby may greatly improve a TLS connection speed; in addition, omitting certificate message transfer may enable multiple TLS handshake messages to be sent at a time, which may avoid a problem that a certificate message is sent for multiple times due to an excessively small buffer size, may further avoid impact of a delayed ACK on the TLS handshake process, and may greatly improve the TLS connection speed. In addition, omitting certificate message transfer may omit a process of verifying a certificate chain, and may greatly reduce CPU overheads of the client and server in the TLS handshake process.

In addition, in the present invention, security of a TLS connection is not lowered, because the certificate is an open resource, and security of the certificate lies in integrity of the certificate. By comparison, a certificate transferred from a peer during each handshake and a locally buffered certificate have no difference in security. For storage overheads caused by the buffered certificate, now many clients already have large storage space. A slight increase of buffer space overheads has no adverse impact.

It should be understood by persons skilled in the art that the accompanying drawings are merely schematic diagrams of an exemplary embodiment, and modules or procedures in the accompanying drawings are not necessarily required for implementing the present invention.

It may be clearly understood by persons skilled in the art that, for the purpose of convenient and brief description, for a detailed working process of the foregoing system, apparatus, and module, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the module division is merely logical function division and may be other division in actual implementation. For example, a plurality of modules or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

When the method provided by the embodiments of this invention is implemented in the form of a software functional unit and sold or used as an independent product, the integrated unit may be stored in a computer-readable storage medium. Based on such an understanding, the technical solutions of the present invention essentially, or the part contributing to the prior art, or a part of the technical solutions may be implemented in a form of a software product. The software product is stored in a storage medium, and includes several instructions for instructing a computer device (which may be a personal computer, a server, or a network device) to perform all or a part of the steps of the methods described in the embodiments of the present invention. The foregoing storage medium includes: any medium that can store program code, such as a USB flash drive, a removable hard disk, a read-only memory (Read-Only Memory, ROM), a random access memory (Random Access Memory, RAM), a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A message sending method, comprising:
sending, by a client, a client handshake message to a server, wherein the client handshake message carries identifiers of server certificates buffered by the client;
receiving, by the client, a server handshake message sent by the server, wherein when the server determines that the identifiers of the server certificates buffered by the client comprise an identifier of a certificate that the server is ready to use, the server handshake message carries the identifier of the certificate that the server is ready to use;
searching, by the client, for a server certificate corresponding to the identifier of the certificate that the server is ready to use, among the server certificates buffered by the client; and
encrypting, by the client by using a public key in the server certificate found by searching, a client key exchange message to be sent, and sending an encrypted client key exchange message to the server.

2. The method according to claim 1, wherein before sending, by a client, a client handshake message to a server, the method further comprises:
in a process of interaction with the server, buffering, by the client, server certificates sent by the server.

3. The method according to claim 1, wherein:
when the server determines that the identifiers of the server certificates buffered by the client do not comprise the identifier of the certificate that the server is ready to use, the server handshake message does not carry the identifier of the certificate that the server is ready to use; and
after receiving, by the client, a server handshake message sent by the server, the method further comprises:
receiving, by the client, a certificate message sent by the server, wherein the certificate message sent by the server carries the server certificate that the server is ready to use, and
buffering, by the client, the server certificate that the server is ready to use, and encrypting, by using the public key in the server certificate that the server is ready to use, the client key exchange message to be sent, and sending the encrypted client key exchange message to the server.

4. The method according to claim 1, wherein before sending, by a client, a client handshake message to a server, the method further comprises:
checking, by the client, validity of the server certificates buffered by the client; and
wherein the identifiers that are of the server certificates buffered by the client and are carried in the client handshake message comprise identifiers of valid server certificates buffered by the client.

5. The method according to claim 1, wherein:
the server handshake message further carries an indication of not requiring the client to send a certificate and carries identifiers of client certificates buffered by the server; and
after receiving, by the client, a server handshake message sent by the server, the method further comprises:
receiving, by the client, a certificate request message sent by the server,
when the client determines that the identifiers of the client certificates buffered by the server comprise an identifier of a certificate that the client is ready to use, sending, by the client, a certificate identifier message to the server according to the certificate request message sent by the server, wherein the certificate identifier message carries the identifier of the certificate that the client is ready to use, and
encrypting, by the client by using a private key that matches the certificate that the client is ready to use, a certificate verification message to be sent, and sending an encrypted certificate verification message to the server, so that after the server finds, by searching, a client certificate corresponding to the identifier of the certificate that the client is ready to use, among the client certificates buffered by the server, the server decrypts the encrypted certificate verification message by using a public key in the client certificate found by searching, so as to verify an identity of the client.

6. The method according to claim 5, wherein after receiving, by the client, a certificate request message sent by the server, the method further comprises:
when the client determines that the identifiers of the client certificates buffered by the server do not comprise the identifier of the certificate that the client is ready to use, sending, by the client, a certificate message to the server according to the certificate request message sent by the server, wherein the certificate message sent by the client carries the client certificate that the client is ready to use; and
encrypting, by the client by using the private key that matches the certificate that the client is ready to use, the certificate verification message to be sent, and sending the encrypted certificate verification message to the server, so that the server decrypts the encrypted certificate verification message by using the public key in the received client certificate, so as to verify the identity of the client.

7. The method according to claim 1, wherein:
the server handshake message further carries an indication of not requiring the client to send a certificate; and
after receiving, by the client, a server handshake message sent by the server, the method further comprises:
receiving, by the client, a certificate request message sent by the server,
sending, by the client, a certificate identifier message to the server, wherein the certificate identifier message carries an identifier of a certificate that the client is ready to use, and
encrypting, by the client by using a private key that matches the certificate that the client is ready to use, a certificate verification message to be sent, and sending an encrypted certificate verification message to the server, so that after the server finds, by searching, the client certificate corresponding to the identifier of the certificate that the client is ready to use, among client certificates buffered by the server, the server decrypts the encrypted certificate verification message by using a public key in the client certificate found by searching, so as to verify an identity of the client.

8. The method according to claim 1, wherein:
the client handshake message further carries an indication of not requiring the server to send a certificate;
that the client handshake message carries identifiers of server certificates buffered by the client comprises that: a first extension is added to the client handshake message, wherein extension data in the first extension is the identifiers of the server certificates buffered by the client; and
that the client handshake message further carries an indication of not requiring the server to send a certificate comprises that: an extension type of the first extension added to the client handshake message is not requiring the server to send a certificate.

9. The method according to claim 1, wherein that the server handshake message carries the identifier of the certificate that the server is ready to use comprises that:
a second extension is added to the server handshake message, wherein extension data in the second extension is the identifier of the certificate that the server is ready to use.

10. The method according to claim 5, wherein that the server handshake message further carries an indication of not requiring the client to send a certificate and carries identifiers of client certificates buffered by the server comprises that:
a third extension is added to the server handshake message, wherein an extension type of the third extension is not requiring the client to send a certificate, and extension data in the third extension is the identifiers of the client certificates buffered by the server.

11. A message sending method, comprising:
sending, by a client, a first client handshake message to a server, wherein the first client handshake message carries an indication of not requiring the server to send a certificate;
receiving, by the client, a server handshake message sent by the server, wherein the server handshake message carries an identifier of a certificate that the server is ready to use; and
if the client finds, by searching, a server certificate corresponding to the identifier of the certificate that the server is ready to use, among server certificates buffered by the client, encrypting, by the client by using a public key in the server certificate found by searching, a client key exchange message to be sent, and sending an encrypted client key exchange message to the server.

12. The method according to claim 11, wherein after receiving, by the client, a server handshake message sent by the server, the method further comprises:
if the client does not find, by searching, the server certificate corresponding to the identifier of the certificate that the server is ready to use, among the server certificates buffered by the client, sending, by the client, a second client handshake message to the server, wherein the second client handshake message does not carry the indication of not requiring the server to send a certificate;
receiving, by the client, a certificate message sent by the server, wherein the certificate message sent by the server carries the server certificate that the server is ready to use; and
buffering, by the client, the server certificate that the server is ready to use, and encrypting, by using the public key in the server certificate, the client key exchange message to be sent, and sending the encrypted client key exchange message to the server.

13. The method according to claim 11, wherein:
that the first client handshake message carries an indication of not requiring the server to send a certificate comprises that: first extension is added to the first client handshake message, wherein an extension type of the first extension is not requiring the server to send a certificate; and
that the server handshake message carries an identifier of a certificate that the server is ready to use comprises that: a second extension is added to the server handshake message, wherein extension data in the second extension is the identifier of the certificate that the server is ready to use.

14. A client, comprising:
a first sending module, a first receiving module, a first searching module, and a first encrypting module;
wherein the first sending module is configured to send a client handshake message to a server, wherein the client handshake message carries identifiers of server certificates buffered by the client; and receive an encrypted client key exchange message from the first encrypting module, and send the encrypted client key exchange message to the server;
wherein the first receiving module is configured to receive a server handshake message sent by the server, wherein when the server determines that the identifiers of the server certificates buffered by the client comprise an identifier of a certificate that the server is ready to use, the server handshake message carries the identifier of the certificate that the server is ready to use; and transfer the identifier of the certificate that the server is ready to use to the first searching module;
wherein the first searching module is configured to receive, from the first receiving module, the identifier of the certificate that the server is ready to use, and search for a server certificate corresponding to the identifier of the certificate that the server is ready to use, among the server certificates buffered by the client; and transfer the server certificate found by searching to the first encrypting module; and
wherein the first encrypting module is configured to receive, from the first searching module, the server certificate found by searching, encrypt, by using a public key in the server certificate found by searching, the client key exchange message to be sent, and transfer the encrypted client key exchange message to the first sending module.

15. The client according to claim 14, further comprising a first buffering module configured to buffer, in a process of interaction with the server, server certificates sent by the server, and transfer the buffered server certificates to the first sending module.

16. The client according to claim 15, wherein:
when the server determines that the identifiers of the server certificates buffered by the client do not comprise the identifier of the certificate that the server is ready to use, the server handshake message received by the first receiving module does not carry the identifier of the certificate that the server is ready to use;
the first receiving module is further configured to receive, after receiving the server handshake message that does not carry the identifier of the certificate that the server is ready to use, a certificate message sent by the server, wherein the certificate message sent by the server carries the server certificate that the server is ready to use; and transfer the server certificate that the server is ready to use to the first buffering module and the first encrypting module separately;
the first buffering module is further configured to receive, from the first receiving module, the server certificate that the server is ready to use, and buffer the server certificate that the server is ready to use; and
the first encrypting module is further configured to receive, from the first receiving module, the server certificate that the server is ready to use, and encrypt, by using the public key in the server certificate that the server is ready to use, the client key exchange message to be sent.

17. The client according to claim 14, further comprising:
a checking module configured to check, before the first sending module sends the client handshake message, validity of the server certificates buffered by the client, and transfer identifiers of valid server certificates buffered by the client to the first sending module; and
wherein the first sending module is further configured to receive, from the checking module, the identifiers of the valid server certificates buffered by the client, wherein the identifiers of the server certificates buffered by the client, which are carried in the client handshake message sent by the first sending module, comprise the identifiers of the valid server certificates buffered by the client.

18. The client according to claim 14, wherein:
the server handshake message received by the first receiving module further carries an indication of not requiring the client to send a certificate and carries identifiers of client certificates buffered by the server;
the first receiving module is further configured to receive, after receiving the server handshake message sent by the server, a certificate request message sent by the server;
the first sending module is further configured to send, when the client determines that the identifiers of the client certificates buffered by the server comprise an identifier of a certificate that the client is ready to use, a certificate identifier message to the server according to the certificate request message sent by the server, wherein the certificate identifier message carries the identifier of the certificate that the client is ready to use; and receive an encrypted certificate verification message from the first encrypting module, and send the encrypted certificate verification message to the server, so that after the server finds, by searching, the client certificate corresponding to the identifier of the certificate that the client is ready to use, among the client certificates buffered by the server, the server decrypts the encrypted certificate verification message by using a public key in the client certificate found by searching, so as to verify an identity of the client; and
the first encrypting module is further configured to encrypt, by using a private key that matches the certificate that the client is ready to use, the certificate verification message to be sent, and transfer the encrypted certificate verification message to the first sending module.

19. The client according to claim 18, wherein:
the first sending module is further configured to send, when the client determines that the identifiers of the client certificates buffered by the server do not comprise the identifier of the certificate that the client is ready to use, a certificate message to the server according to the certificate request message sent by the server, wherein the certificate message sent by the first sending module carries the client certificate that the client is ready to use.

20. The client according to claim 14, wherein:
the server handshake message received by the first receiving module further carries an indication of not requiring the client to send a certificate;
the first receiving module is further configured to receive, after receiving the server handshake message sent by the server, a certificate request message sent by the server;
the first sending module is further configured to send a certificate identifier message to the server, wherein the certificate identifier message carries an identifier of a certificate that the client is ready to use; and receive the encrypted certificate verification message from the first encrypting module, and send the encrypted certificate verification message to the server, so that after the server finds, by searching, the client certificate corresponding to the identifier of the certificate that the client is ready to use, among client certificates buffered by the server, the server decrypts the encrypted certificate verification message by using a public key in the client certificate found by searching, so as to verify an identity of the client; and
the first encrypting module is further configured to encrypt, by using a private key that matches the certificate that the client is ready to use, the certificate verification message to be sent, and transfer the encrypted certificate verification message to the first sending module.

21. A client, comprising:
a second sending module, a second receiving module, a second searching module, and a second encrypting module;
wherein the second sending module is configured to send a first client handshake message to a server, wherein the first client handshake message carries an indication of not requiring the server to send a certificate; and receive an encrypted client key exchange message from the second encrypting module, and send the encrypted client key exchange message to the server;
wherein the second receiving module is configured to receive a server handshake message sent by the server, wherein the server handshake message carries an identifier of a certificate that the server is ready to use; and transfer the identifier of the certificate that the server is ready to use to the second searching module;
wherein the second searching module is configured to receive, from the second receiving module, the identifier of the certificate that the server is ready to use, and search for a server certificate corresponding to the identifier of the certificate that the server is ready to use, among server certificates buffered by the client; and when finding, by searching, by searching, the server certificate corresponding to the identifier of the certificate that the server is ready to use, transfer the server certificate found by searching to the second encrypting module; and
wherein the second encrypting module is configured to receive, from the second searching module, the server certificate found by searching, encrypt, by using a public key in the server certificate found by searching, the client key exchange message to be sent, and transfer the encrypted client key exchange message to the second sending module.

22. The client according to claim 21, further comprising:
a second buffering module further configured to receive, from the second receiving module, the server certificate that the server is ready to use, and buffer the server certificate that the server is ready to use;
wherein the second sending module is further configured to send a second client handshake message to the server again when the second searching module does not find, by searching, the server certificate corresponding to the identifier of the certificate that the server is ready to use, among the server certificates buffered by the client, wherein the second client handshake message does not carry the indication of not requiring the server to send a certificate;
wherein the second receiving module is further configured to receive a certificate message sent by the server, wherein the certificate message sent by the server carries the server certificate that the server is ready to use; and transfer the server certificate that the server is ready to use to the second buffering module and the second encrypting module separately; and
the second encrypting module is further configured to receive, from the second receiving module, the server certificate that the server is ready to use, and encrypt, by using the public key in the server certificate, the client key exchange message to be sent.
